(19) United States
(12) Patent Application Publication
(10) Pub. No.: US 2024/0187968 A1
(43) Pub. Date: Jun. 6, 2024

(54) METHOD OF USER EQUIPMENT (UE), METHOD OF ACCESS AND MOBILITY MANAGEMENT FUNCTION (AMF), METHOD OF UNIFIED DATA MANAGEMENT (UDM), UE, AMF AND UDM

(71) Applicant: NEC Corporation, Minato-ku, Tokyo (JP)

(72) Inventors: Kundan TIWARI, Minato-ku, Tokyo (JP); Toshiyuki TAMURA, Minato-ku, Tokyo (JP)

(73) Assignee: NEC Corporation, Minato-ku, Tokyo (JP)

(21) Appl. No.: 18/285,270

(22) PCT Filed: Feb. 1, 2022
(86) PCT No.: PCT/JP2022/003743

§ 371 Date: Oct. 2, 2023

(30) Foreign Application Priority Data
Apr. 8, 2021 (IN) 202111016593

(51) Int. Cl. H04W 48/02; H04W 12/06; H04W 48/18; H04W 60/04; H04W 84/04

(52) U.S. Cl. CPC H04W 48/02; H04W 12/06; H04W 48/18; H04W 60/04; H04W 84/042

(57) ABSTRACT

A method according to the present disclosure is a method for a Unified Data Management Function (UDM) including: keeping information for a Permanent Equipment Identifier (PEI) regarding a User Equipment (UE); and sending, to an Access Management Function (AMF), first information regarding the UE based on the information for the PEI.

### TECHNICAL FIELD

The present disclosure relates to a method of a user equipment (UE), a method of an access and mobility management function (AMF), a method of a unified data management (UDM), a UE, an AMF and a UDM.

### BACKGROUND ART

A User Equipment (UE) includes Mobile Equipment (ME) and a Universal Integrated Circuit Card (UICC) containing a Universal Subscriber Identity Module (USIM) or embedded Subscriber Identity Module (eSIM). A ME has a unique identifier Permanent Equipment Identifier (PEI) stored permanently in the ME. The UICC contains a USIM application which contains various subscription data (e.g. SUbscriber Permanent Unique Identifier (SUPI), International Mobile Subscriber Identity (IMSI)), security parameters (e.g. Authentication Key K) for the user. When a user gets subscription to a PLMN, the user is given a UICC (also popularly called SIM) which contains SUPI/IMSI. The user in the PLMN is uniquely identified by the SUPI/IMSI stored in the UICC. The Unified Data Management (UDM) stores various subscription parameters (e.g. SUPI, IMSI), security parameters (e.g. Authentication Key K) and other parameters related to the SUPI of the USIM. The UICC is inserted to the ME by a user of the UE. Inserting UICC may be called as inserting SIM or inserting USIM.

When a user (or a UE) registers a PLMN then the UE sends Subscription Concealed Identifier (SUCI) to an AMF. The SUCI is generated by the UE based on the SUPI. For example, the SUCI is generated by concealing the SUPI. The AMF initiates authentication procedure to the AUSF which subsequently initiates authentication procedure to the UDM. As a part of authentication procedure the SUCI is transferred from AMF to UDM via AUSF. The UDM de-conceals the SUCI to the SUPI. When the authentication procedure between the UE and the PLMN is executed successfully then the UDM sends 5GS Mobility Management (5GMM) parameter(s) (e.g. subscription parameters) to the UE via the AMF during registration procedure. These parameters are used by the UE in various Non-Access-Stratum (NAS) or Access-Stratum (AS) procedures. The UE stores these parameters in the non-volatile memory and uses them after the UE is powered cycles. While some 5GMM parameter(s) are stored in the non-volatile memory in UICC, some 5GMM parameter(s) are stored in the non-volatile memory in the ME. These 5GMM parameter(s) are needed for the correct execution of various NAS or AS procedures or also avail the various services subscribed by the subscriber.

### CITATION LIST

### Non Patent Literature

[NPL 1] 3GPP TR 21.905: “Vocabulary for 3GPP Specifications”. V17.0.0 (2020-07)
[NPL 2] GSM Association Official Document NG.116: “Generic Network Slice Template” V2.0 (2019-10)—https://www.gsma.com/newsroom/wp-content/uploads/NG.116-v2.0.pdf
[NPL 3] 3GPP TR 22.835: “Study on Enhanced Access to and Support of Network Slices” V0.2.0 (2020-11)—http://www.3gpp.org/ftp/Specs/archive/22_series/22.835/22835-020.zip
[NPL 4] 3GPP TS 23.501: “System architecture for the 5G System (5GS)”. V17.0.0 (2021-03)
[NPL 5] 3GPP TS 23.502: “Procedures for the 5G System (5GS)”. V17.0.0 (2021-03)
[NPL 6] 3GPP TS 24.501: “Non-Access-Stratum (NAS) protocol for 5G System (5GS); Stage 3”. V17.1.0 (2020-12)
[NPL 7] 3GPP TS 33.501: “Security Architecture and Procedures for 5G System”. V17.0.0 (2020-12)

### SUMMARY OF INVENTION

### Technical Problem

When a user inserts a new SIM (e.g. a new USIM) to a ME or activates a new USIM in a ME while there was an original USIM associated in the ME, the UE deletes the 5GMM parameter(s) for the original USIM stored in the non-volatile memory of the ME if the SUPI associated with stored 5GMM parameter(s) is different than the SUPI of the new SIM or the new USIM. For example, the original USIM is inserted to the ME before the new USIM is inserted to the ME. When the original USIM is inserted, the UE (e.g. the ME) receives 5GMM parameter(s) for the original USIM from the UDM, and stores the 5GMM parameter(s) for the original USIM. In addition, the user may activate the new USIM instead of the original USIM. Further, inserting the new USIM to the ME instead of the original USIM or activating the new USIM instead of the original USIM may be called as swapping from the original USIM to the new USIM. For example, the original USIM is removed from the ME, then the new USIM is inserted to the ME.

In this scenario the ME receives new 5GMM parameter(s) for the new SIM from a UDM and stores the new 5GMM parameter(s) for the new SIM or new USIM in the non-volatile memory after successful registration procedure for the new SIM or new USIM. Thereafter, when the original USIM is inserted to the ME again or the original USIM is activated again in the ME, the ME may not receive the associated 5GMM parameter(s) from the network (e.g. the UDM) during the registration procedure as the network believes that the UE holds the valid associated 5GMM parameter(s) for the original USIM.

For example, when the original USIM is inserted for the first time, and the first registration procedure for the original USIM is performed, the network (e.g. UDM) sends 5GMM parameter(s) for the original USIM and stores association of the original USIM and the PEI for the registered UE. When the new USIM is inserted instead of the original USIM, and the original USIM is inserted again instead of the new USIM, the second registration procedure is performed. In this case, there is a case where the network does not send the 5GMM parameter(s) for the original USIM because the network already stores the association of the original USIM and the PEI. That is, the network does not know that the 5GMM parameter(s) for the original USIM is deleted in the UE. In other words, there is no way which the network knows swapping USIM occurs. In other words, the network does not know that swapping USIM occurs.

As the consequence, the UE loses the 5GMM parameter(s) for the original USIM as all 5GMM parameter(s) for the original USIM in the non-volatile memory of the ME was deleted when the new USIM is inserted to the ME. In other words, the UE (e.g. the ME) does not have the 5GMM parameter(s) for the original USIM when the original USIM is inserted again. With the absence of the 5GMM parameter(s) in the ME, the UE may lose some subscribed services as long as 5GMM parameter(s) mismatch between the UE and the network continues.

### Solution to Problem

In an aspect of the present disclosure, a method of a user equipment (UE) includes sending an indicator indicating that association of Permanent Equipment Identifier (PEI) and Subscription Permanent Identifier (SUPI) related to the UE is changed; and receiving a 5GS Mobility Management (5GMM) parameter related to the UE after sending the indicator.

In an aspect of the present disclosure, a method of an access and mobility management function (AMF) includes receiving, from a user equipment (UE), an indicator indicating that association of Permanent Equipment Identifier (PEI) and Subscription Permanent Identifier (SUPI) related to the UE is changed; sending the indicator to a Unified Data Management (UDM) in case of receiving the indicator from the UE; receiving, from the UDM, a 5GS Mobility Management (5GMM) parameter related to the UE after sending the indicator; and sending, to the UE, the 5GMM parameter.

In an aspect of the present disclosure, a method of a unified data management (UDM) includes receiving an indicator indicating that association of Permanent Equipment Identifier (PEI) and Subscription Permanent Identifier (SUPI) related to a user equipment (UE) is changed; and sending a 5GS Mobility Management (5GMM) parameter related to the UE after receiving the indicator.

In an aspect of the present disclosure, a method of an access and mobility management function (AMF) includes receiving, from a user equipment (UE), a registration request message; sending, to a Unified Data Management (UDM), Permanent Equipment Identifier (PEI) related to the UE and Subscription Permanent Identifier (SUPI) related to the UE after receiving the registration request message; receiving, from the UDM, a 5GS Mobility Management (5GMM) parameter related to the UE after sending the PEI and the SUPI; and sending, to the UE, the 5GMM parameter.

In an aspect of the present disclosure, a method of a unified data management (UDM) includes receiving Permanent Equipment Identifier (PEI) related to a user equipment (UE) and Subscription Permanent Identifier (SUPI) related to the UE; and sending a 5GS Mobility Management (5GMM) parameter related to the UE after receiving the PEI and the SUPI.

In an aspect of the present disclosure, a method of an access and mobility management function (AMF) includes receiving, from a user equipment (UE), a registration request message; determining whether association of Permanent Equipment Identifier (PEI) and Subscription Permanent Identifier (SUPI) related to the UE is changed; sending an indicator indicating that the association is changed to a Unified Data Management (UDM) in a case of determining the association is changed; receiving, from the UDM, a 5GS Mobility Management (5GMM) parameter related to the UE after sending the indicator; and sending, to the UE, the 5GMM parameter.

In an aspect of the present disclosure, a method of a unified data management (UDM) includes determining whether association of Permanent Equipment Identifier (PEI) and Subscription Permanent Identifier (SUPI) related to a user equipment (UE) is changed; and sending a 5GS Mobility Management (5GMM) parameter related to the UE in a case of determining the association is changed.

In an aspect of the present disclosure, a user equipment (UE) includes means for sending an indicator indicating that association of Permanent Equipment Identifier (PEI) and Subscription Permanent Identifier (SUPI) related to the UE is changed; and means for receiving a 5GS Mobility Management (5GMM) parameter related to the UE after sending the indicator.

In an aspect of the present disclosure, an access and mobility management function (AMF) includes means for receiving, from a user equipment (UE), an indicator indicating that association of Permanent Equipment Identifier (PEI) and Subscription Permanent Identifier (SUPI) related to the UE is changed; means for sending the indicator to a Unified Data Management (UDM) in case of receiving the indicator from the UE; means for receiving, from the UDM, a 5GS Mobility Management (5GMM) parameter related to the UE after sending the indicator; and means for sending, to the UE, the 5GMM parameter.

In an aspect of the present disclosure, a unified data management (UDM) includes means for receiving an indicator indicating that association of Permanent Equipment Identifier (PEI) and Subscription Permanent Identifier (SUPI) related to a user equipment (UE) is changed; and means for sending a 5GS Mobility Management (5GMM) parameter related to the UE after receiving the indicator.

In an aspect of the present disclosure, an access and mobility management function (AMF) includes means for receiving, from a user equipment (UE), a registration request message; means for sending, to a Unified Data Management (UDM), Permanent Equipment Identifier (PEI) related to the UE and Subscription Permanent Identifier (SUPI) related to the UE after receiving the registration request message; means for receiving, from the UDM, a 5GS Mobility Management (5GMM) parameter related to the UE after sending the PEI and the SUPI; and means for sending, to the UE, the 5GMM parameter.

In an aspect of the present disclosure, a unified data management (UDM) includes means for receiving Permanent Equipment Identifier (PEI) related to a user equipment (UE) and Subscription Permanent Identifier (SUPI) related to the UE; and means for sending a 5GS Mobility Management (5GMM) parameter related to the UE after receiving the PEI and the SUPI.

In an aspect of the present disclosure, an access and mobility management function (AMF) includes means for receiving, from a user equipment (UE), a registration request message; means for determining whether association of Permanent Equipment Identifier (PEI) and Subscription Permanent Identifier (SUPI) related to the UE is changed; means for sending an indicator indicating that the association is changed to a Unified Data Management (UDM) in a case of determining the association is changed; means for receiving, from the UDM, a 5GS Mobility Management (5GMM) parameter related to the UE after sending the indicator; and means for sending, to the UE, the 5GMM parameter.

In an aspect of the present disclosure, a unified data management (UDM) includes means for determining whether association of Permanent Equipment Identifier (PEI) and Subscription Permanent Identifier (SUPI) related to a user equipment (UE) is changed; and means for sending a 5GS Mobility Management (5GMM) parameter related to the UE in a case of determining the association is changed.

### BRIEF DESCRIPTION OF DRAWINGS

FIG. 1 illustrates Registration procedure to configure the UE subscription parameter according to First example embodiment.

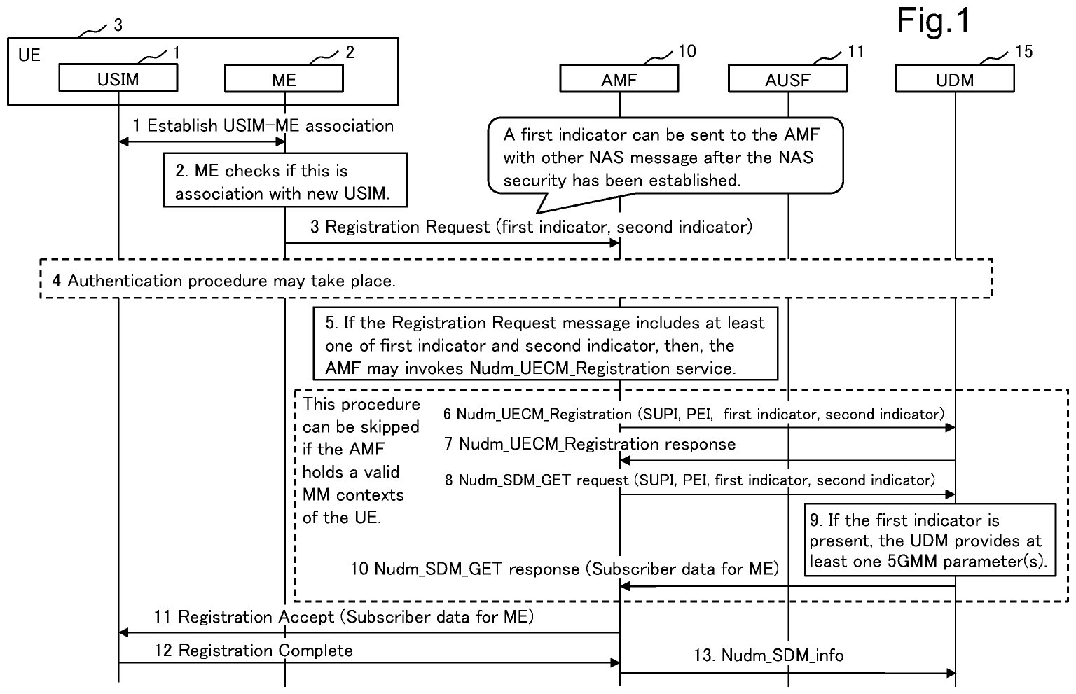

FIG. 2 illustrates Registration procedure to configure the UE subscription parameter according to Second example embodiment.

FIG. 3 illustrates Registration procedure to configure the UE subscription parameter according to Third example embodiment.

FIG. 4 illustrates Variant 1 to the registration procedure defined in FIG. 3.

FIG. 5 illustrates Variant 2 to the registration procedure defined in FIG. 3.

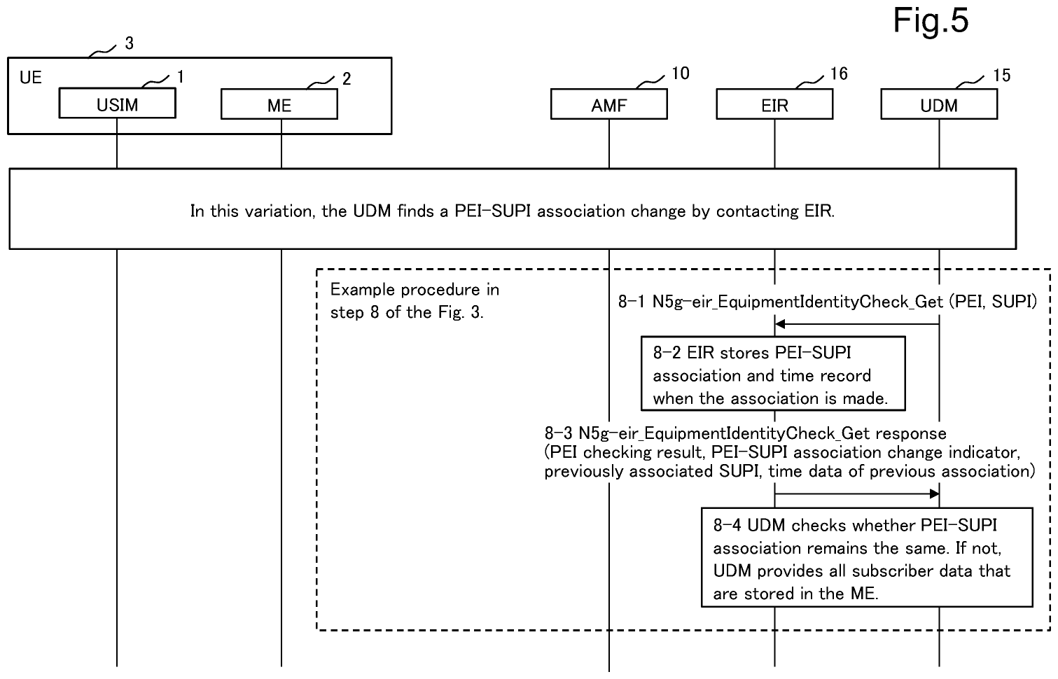

FIG. 6 is a block diagram for a UE.

FIG. 7 is a block diagram for a (R)AN node.

FIG. 8 is a block diagram for an AMF.

FIG. 9 is a block diagram for a UDM.

FIG. 10 is a block diagram for an EIR.

FIG. 11 illustrates Registration procedure.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP Inter Working Function
N5CW Non-5G-Capable over WLAN
NAI Network Access Identifier
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method.

Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the embodiments disclosed herein in addition to, or instead of, a system, and all such embodiments are contemplated as within the scope of the present disclosure.

In the example embodiments defined below, 5GMM parameter(s) may be UE subscription parameter(s) stored in the UDM. The UDM sends this parameters during the registration procedure or the UE configuration update procedure to the UE. The UE stores these parameters and SUPI of the USIM in the non-volatile memory in the ME. The UE uses the 5GMM parameter(s) in various UE NAS or AS procedures. When the UE PEI-SUPI association is changed in the ME, the ME deletes the stored 5GMM parameter(s). For example, when a first USIM is inserted to the ME, the UE (e.g. the ME) stores first association of a PEI corresponding to the ME and the SUPI corresponding to the first USIM (this association may be called as UE PEI-SUPI association, or PEI-SUPI association). And when a second USIM is inserted to the ME instead of the first USIM, the UE (e.g. the ME) stores second association of PEI corresponding to the ME and a SUPI corresponding to the second USIM, and deletes the first association and 5GMM parameter(s) for the first USIM. That is, when the second USIM is inserted instead of the first USIM, the UE PEI-SUPI association is changed.

Following is an example of the 5GMM parameter(s) that can be stored in the non-volatile memory in the ME. In the current disclosure the 5GMM parameter(s) are not limited to the 5GMM parameter(s) listed below.
a) 5G-GUTI;
b) last visited registered Tracking Area Identity (TAI);
c) 5GS update status;
d) 5G NAS security context parameters from a full native 5G NAS security context (see NPL 7);
e) KAUSF and KSEAF (see NPL 7);
f) Steering of Roaming (SOR) counter (see NPL 7); and
g) UE parameter update counter (see NPL 7).
h) configuration of compatible slices in a UE. (see NPL 4).
i) onboarding parameter related to Non-Public Network (NPN) both standalone private network and Public Network Integrated—NPN. This parameters are configured in the UE to find and camp private network (e.g. when the UE switched on the first time).

In the example embodiments below, 5GMM parameter(s) may be sent to the UE using UE configuration update procedure, during registration procedure (e.g. initial registration procedure) or after the registration procedure finished.

The UE needs Closed Access Group (CAG) information (e.g. Allowed CAG list) to camp and register to a Public Network Integrated Non-Public Network (PNI-NPN). When a first USIM is inserted in the ME and the UE performs registration procedure for the first USIM, the UDM sends CAG information for the first USIM to the UE during the registration procedure or UE configuration update procedure.

For example, the CAG information is one of the 5GMM parameter(s). The UE stores the CAG information to its non-volatile memory in the ME. The UE subsequently uses CAG information to camp on the subscribed CAG cell and gets services related from the PLMN. When a second USIM is inserted the ME instead of the first USIM, the ME deletes the CAG information for the first USIM.

When the first USIM is again inserted, the UE does not have CAG information for the first USIM.

In absence of the CAG information for the first USIM, the UE cannot find a CAG cell(s) for which the user has subscription and therefore cannot register to the PNI-NPN. In this situation, the UE can't access to the PNI-NPN even the UE has a valid subscription.

In the example embodiments below, the term USIM may also represent eSIM/eUICC when eSIM/eUICC is part of the UE. When the term USIM is used for eSIM/eUICC, then the term “USIM is inserted” or “USIM is activated” means that “eSIM/eUICC is provisioned with a new user profile (e.g. a new SUPI and other eSIM Directory File (DF) or Elementary File (EF) relate to the new SUPI.)”.

In the below example embodiments, when the registration request message indicates PEI-SUPI association changes or the Kausf is deleted from the ME memory or all 5GMM parameters are deleted (non-volatile memory is cleaned) when the USIM is removed and inserted again in the UE and the AMF has a valid context of the UE identified by 5G-GUTI received in the registration request message, the AMF initiates authentication procedure to the UDM as described in NPL 7. Alternatively, when the UDM receives Nudm_UECM_Registration containing the first indicator indicating SUPI-PEI association changed or second indicator indicating Kausf is deleted or 5GMM parameter(s) are deleted then UDM sends Nudm_UECM_Registration Response message indicating the AMF to initiate authentication procedure to the UDM via AUSF as described in NPL 7. Upon successful authentication procedure and subsequently registration procedure, the UE and AUSF start using the latest Kausf created during the authentication procedure.

### First Example Embodiment Solving Problem Description (Solution 1: UE Indicates Change in PEI-SUPI Association to the Network)

The UE indicates change in PEI-SUPI association to the network and the network updates the UE with the subscription of the current USIM.

The detailed steps of the registration procedure are as described below:

1. A first USIM is activated in a ME. For example, when the first USIM is inserted to the ME, the first USIM is activated in the ME. The ME creates association with PEI of the ME and SUPI of the first USIM, and stores the association.

2. The ME checks if the ME has 5GMM parameter(s) for the first USIM stored in the ME.

For example, the ME may check if this is association with new USIM by checking if the ME has a 5GMM parameter for the first USIM stored in the ME.

A case where the ME (or the UE) has no 5GMM parameter(s) stored for the first USIM is, for example, a case i) the ME had a second USIM activated and the user activated/inserted the first USIM again then the ME does not have the 5GMM parameter(s) for the first USIM or a case ii) the first USIM was stored in the ME memory and the 5GMM parameter(s) are deleted from ME memory because the ME was hard reset. An example of the case i) is a case where the first USIM is inserted again after the second USIM is inserted instead of the first USIM. If the ME determines that the ME has no 5GMM parameter for the first USIM, the UE (e.g. the ME) determines that PEI-SUPI association has changed. For example, the UE (e.g. the ME) determines that association of PEI corresponding to the ME and a SUPI corresponding to the second USIM is changed to association of the PEI and a SUPI corresponding to the first USIM.

3. The UE initiates registration procedure to a network (e.g. an AMF) by sending Registration Request message. For example the UE initiates initial registration procedure by sending Registration Request message. When the UE (e.g. the ME) determines that the ME has no 5GMM parameter for the first USIM (or the UE determines that association of PEI corresponding to the ME and a SUPI corresponding to the second USIM is changed to association of the PEI and a SUPI corresponding to the first USIM), the UE sends the Registration Request message with at least one of the following indicator,
i) a first indicator (e.g. USIM update indicator), indicating that the PEI-SUPI association has changed in the ME, and
ii). a second indicator, indicating that the UE does not have a valid one or some 5GMM parameter(s) for the first USIM stored in the ME memory.

In one example, the first indicator and the second indicator are sent as a non-cleartext IE as defined in NPL 6. In another example the first indicator and the second indicator are sent as a cleartext IE as defined in NPL 6.

The first indicator may indicate that swapping USIM occurs. The second indicator may indicate 5GMM parameter(s) that the UE (e.g. the ME) requires. The first indicator may be called as an indicator indicating that association of PEI and Subscription Permanent Identifier SUPI related to the UE is changed. The first indicator may indicate when the PEI-SUPI association has changed in the ME after the successful Registration Procedure with current PLMN. The first indicator may indicate when the PEI-SUPI association has changed in the ME after the successful Registration Procedure with current associated AMF. The first indicator may indicate when the PEI-SUPI association has changed in the ME after the successful Registration Procedure with current access type, either 3GPP access or non-3GPP access. The second indicator may indicate that the UE has lost a valid one or some 5GMM parameter(s) after the successful Registration Procedure with current PLMN. The second indicator may indicate that the UE has lost a valid one or some 5GMM parameter(s) after the successful Registration Procedure with current associated AMF. The second indicator may indicate that the UE has lost a valid one or some 5GMM parameter(s) after the successful Registration Procedure with current access type, either 3GPP access or non-3GPP access.

4. Upon reception of the Registration Request message, the AMF may initiate authentication procedure. Note that the first indicator and the second indicator can be sent from the UE to the AMF by any new or existing NAS message, for example Security Mode Complete message, after the NAS security has been established.

5. When the AMF receives at least one of first indicator and second indicator in the Registration Request message, the AMF checks whether the AMF has a valid MM contexts for the UE (e.g. 5GMM parameter(s) for the first USIM). If the AMF has the valid MM contexts for the UE, then step 6 to step 10 are skipped and the process proceeds to step 11. Otherwise, the process proceeds to step 6.

Alternatively, the AMF shall always perform step 6. This is a case where the UDM provides a reporting event service for Change of PEI-SUPI association.

6. The AMF sends Nudm_UECM_Registration message to the UDM. The Nudm_UECM_Registration message includes SUPI, PEI, and at least one of the first indicator and the second indicator. For example the SUPI included in Nudm_UECM_Registration message is a SUPI corresponding to the first USIM, and the PEI included in Nudm_UECM_Registration message is a PEI corresponding to the ME. The AMF may obtain the SUPI and the PEI from the Registration Request message or during Authentication procedure in step 4 or by any new or existing NAS message, for example Security Mode Complete message, after the NAS security has been established by the authentication procedure. For example, if the registration request message in step 3 includes the first indicator, the Nudm_UECM_Registration message includes the first indicator. For example, if the registration request message in step 3 includes the second indicator, the Nudm_UECM_Registration message includes the second indicator. For example, if the registration request in step 3 message includes the first indicator and the second indicator, the Nudm_UECM_Registration message includes the first indicator and the second indicator.

7. In response of the Nudm_UECM_Registration message, the UDM sends Nudm_UECM_Registration response message to the AMF.

8. The AMF sends Nudm_SDM_GET request message to the UDM. The Nudm_SDM_GET request message includes SUPI, PEI, and at least one of the first indicator and the second indicator. For example the SUPI included in Nudm_SDM_GET request message is a SUPI corresponding to the first USIM, and the PEI included in Nudm_SDM_GET request message is a PEI corresponding to the ME.

For example, if the registration request message in step 3 includes the first indicator, the Nudm_SDM_GET request message includes the first indicator. For example, if the registration request message in step 3 includes the second indicator, the Nudm_SDM_GET request message includes the second indicator. For example, if the registration request in step 3 message includes the first indicator and the second indicator, the Nudm_SDM_GET request message includes the first indicator and the second indicator.

9-10. Upon reception of Nudm_SDM_GET request message, the UDM sends, to the AMF, Nudm_SDM_GET response message containing at least one 5GMM parameter(s) for the first USIM if the Nudm_SDM_GET request message or Nudm_UECM_Registration message contains the first indicator. If the Nudm_SDM_GET request message contains the second indicator but not the first indicator, the UDM sends the 5GMM parameter(s) for the first USIM as indicated by the second indicator in the Nudm_SDM_GET response message. For example, the UDM finds at least one 5GMM parameter(s) for the first USIM based on the received SUPI or PEI in the step 6 or 8, and sends, to the AMF, the Nudm_SDM_GET response message containing at least one 5GMM parameter(s) for the first USIM.

The AMF may store the 5GMM parameter(s) received from the UDM. The AMF may store the PEI-SUPI association (e.g. association of PEI corresponding to the ME and SUPI corresponding to the first USIM).

If the UDM provides a reporting event service for change of PEI-SUPI association, the UDM notifies new PEI-SUPI association to service consumers. The service consumer can be NEF, AF or any other entity. For example, when the UDM receives the first indicator in the Nudm_UECM_Registration message or the Nudm_SDM_GET request message, the UDM notifies new PEI-SUPI association (e.g. association of PEI corresponding to the ME and SUPI corresponding to the first USIM) to service consumers. The UDM may store the PEI-SUPI association (e.g. association of PEI corresponding to the ME and SUPI corresponding to the first USIM).

11. Upon reception of the Nudm_SDM_GET response message from the UDM, the AMF sends Registration Accept message containing the 5GMM parameter(s). The 5GMM parameter(s) can be the one received in the Nudm_SDM_GET response message from the UDM (step 10) or stored in the AMF in MM context for the UE (Step 5).

12. Upon reception of the Registration Accept message containing the 5GMM parameter(s) from the AMF, the UE sends Registration Complete message to the AMF. The UE stores the 5GMM parameter(s) and uses them in the related subsequent procedure. For example, the UE sends the Registration Complete message to acknowledge reception of the 5GMM parameter(s).

13. Upon reception of the Registration Complete message from the UE, the AMF sends, to the UDM, a message indicating successful delivery of the 5GMM parameter(s). The message may be Nudm_SDM_info message.

According to procedure as mentioned above, the UE sends at least one of the first indicator and the second indicator if the first USIM is inserted again (or if swapping USIM is occurs), and the network (e.g. the AMF and the UDM) sends 5GMM parameter(s) for the first USIM to the UE.

As the consequence, the UE can receive the 5GMM parameter(s) for the first USIM and store them.

Hence, the UE can receive some subscribed services based on the 5GMM parameter(s) for the first USIM. In addition, 5GMM parameter(s) and PEI-SUPI association can synchronize between the UE and the network (e.g. the AMF and the UDM).

Further, the UE can receive the CAG information as one of the 5GMM parameter(s), hence the UE can find a CAG cell(s) for which the user has subscription and therefore can register to the PNI-NPN.

In this situation, the UE can access to the PNI-NPN.

### Second Example Embodiment Solving Problem Description (Solution 2: UDM Always Provides the 5GMM Parameters)

The UDM always provides the 5GMM parameter(s) when the UE is registering to the network.

The detailed steps of the registration procedure are described below:

1. A first USIM is activated in a ME. For example, when the first USIM is inserted to the ME, the first USIM is activated in the ME. The ME creates association with PEI of the ME and SUPI of the first USIM, and stores the association.

2. The ME checks if the ME has 5GMM parameter(s) for the first USIM stored in the ME.

For example, the ME may check if this is association with new USIM by checking if the ME has a 5GMM parameter for the first USIM stored in the ME.

A case where the ME has no 5GMM parameter(s) stored for the first USIM is, for example, a case i) the ME had a second USIM activated and the user activated/inserted the first USIM again then the ME does not have the 5GMM parameter(s) for the first USIM or a case ii) the first USIM was stored in the ME memory and the 5GMM parameter(s) are deleted from ME memory because the ME was hard reset. An example of the case i) is a case where the first USIM is inserted again after the second USIM is inserted instead of the first USIM. If the ME determines that the ME has no 5GMM parameter for the first USIM, the UE (e.g. the ME) determines that PEI-SUPI association has changed. For example, the UE (e.g. the ME) determines that association of PEI corresponding to the ME and a SUPI corresponding to the second USIM is changed to association of the PEI and a SUPI corresponding to the first USIM.

3. The UE initiates registration procedure to a network (e.g. an AMF) by sending Registration Request message. For example the UE initiates initial registration procedure by sending Registration Request message. When the UE (e.g. the ME) determines that the ME has no 5GMM parameter for the first USIM (or the UE determines that association of PEI corresponding to the ME and a SUPI corresponding to the second USIM is changed to association of the PEI and a SUPI corresponding to the first USIM), the UE sends the Registration Request message with at least one of the following indicator,
i) a first indicator (e.g. USIM update indicator), indicating that the PEI-SUPI association has changed in the ME, and
ii).a second indicator, indicating that the UE does not have a valid one or some 5GMM parameter(s) for the first USIM stored in the ME memory.

In one example, the first indicator and the second indicator are sent as a non-cleartext IE as defined in NPL 6. In another example the first indicator and the second indicator are sent as a cleartext IE as defined in NPL 6.

The first indicator may indicate that swapping USIM occurs. The second indicator may indicate 5GMM parameter(s) that the UE (e.g. the ME) requires.

4. Upon reception of the Registration Request message, the AMF may initiate authentication procedure. Note that the first indicator and the second indicator can be sent from the UE to the AMF by any new or existing NAS message, for example Security Mode Complete message, after the NAS security has been established.

5. When the AMF receives at least one of first indicator and second indicator in the Registration Request message, the AMF checks whether the AMF has a valid MM contexts for the UE (e.g. 5GMM parameter(s) for the first USIM). If the AMF has the valid MM contexts for the UE, then step 6 to step 10 are skipped and the process proceeds to step 11. Otherwise, the process proceeds to step 6.

Alternatively, the AMF shall always perform step 6. This is a case where the UDM provides a reporting event service for Change of PEI-SUPI association.

6. The AMF sends Nudm_UECM_Registration message to the UDM. The Nudm_UECM_Registration message includes SUPI, and PEI. For example the SUPI included in Nudm_UECM_Registration message is a SUPI corresponding to the first USIM, and the PEI included in Nudm_UECM_Registration message is a PEI corresponding to the ME. The AMF may obtain the SUPI and the PEI from the Registration Request message or during Authentication procedure in step 4 or by any new or existing NAS message, for example Security Mode Complete message, after the NAS security has been established by the authentication procedure.

7. In response of the Nudm_UECM_Registration message, the UDM sends Nudm_UECM_Registration response message to the AMF.

8. The AMF sends Nudm_SDM_GET request message to the UDM. The Nudm_SDM_GET request message includes SUPI, and PEI. For example the SUPI included in Nudm_SDM_GET request message is a SUPI corresponding to the first USIM, and the PEI included in Nudm_SDM_GET request message is a PEI corresponding to the ME.

9-10. Upon reception of Nudm_SDM_GET request message, the UDM sends, to the AMF, Nudm_SDM_GET response message containing at least one 5GMM parameter(s) for the first USIM. For example, upon reception of Nudm_SDM_GET request message, the UDM always sends, to the AMF, the Nudm_SDM_GET response message containing at least one 5GMM parameter(s). In addition, for example, the UDM finds at least one 5GMM parameter(s) for the first USIM based on the received SUPI or PEI in the step 8, and sends, to the AMF, the Nudm_SDM_GET response message containing at least one 5GMM parameter(s) for the first USIM.

If the UDM provides a reporting event service for change of PEI-SUPI association, the UDM notifies new PEI-SUPI association to service consumers. The service consumer can be NEF, AF or any other entity. For example, when the UDM receives the Nudm_UECM_Registration message or the Nudm_SDM_GET request message, the UDM notifies new PEI-SUPI association (e.g. association of PEI corresponding to the ME and SUPI corresponding to the first USIM) to service consumers. The UDM may store the PEI-SUPI association (e.g. association of PEI corresponding to the ME and SUPI corresponding to the first USIM).

11. Upon reception of the Nudm_SDM_GET response message from the UDM, the AMF sends Registration Accept message containing the 5GMM parameter(s). The 5GMM parameter(s) can be the one received in the Nudm_SDM_GET response message from the UDM (step 10) or stored in the AMF in MM context for the UE (Step 5).

12. Upon reception of the Registration Accept message containing the 5GMM parameter(s) from the AMF, the UE sends Registration Complete message to the AMF. The UE stores the 5GMM parameter(s) and uses them in the related subsequent procedure. For example, the UE sends the Registration Complete message to acknowledge reception of the 5GMM parameter(s).

13. Upon reception of the Registration Complete message from the UE, the AMF sends, to the UDM, a message indicating successful delivery of the 5GMM parameter(s). The message may be Nudm_SDM_info message.

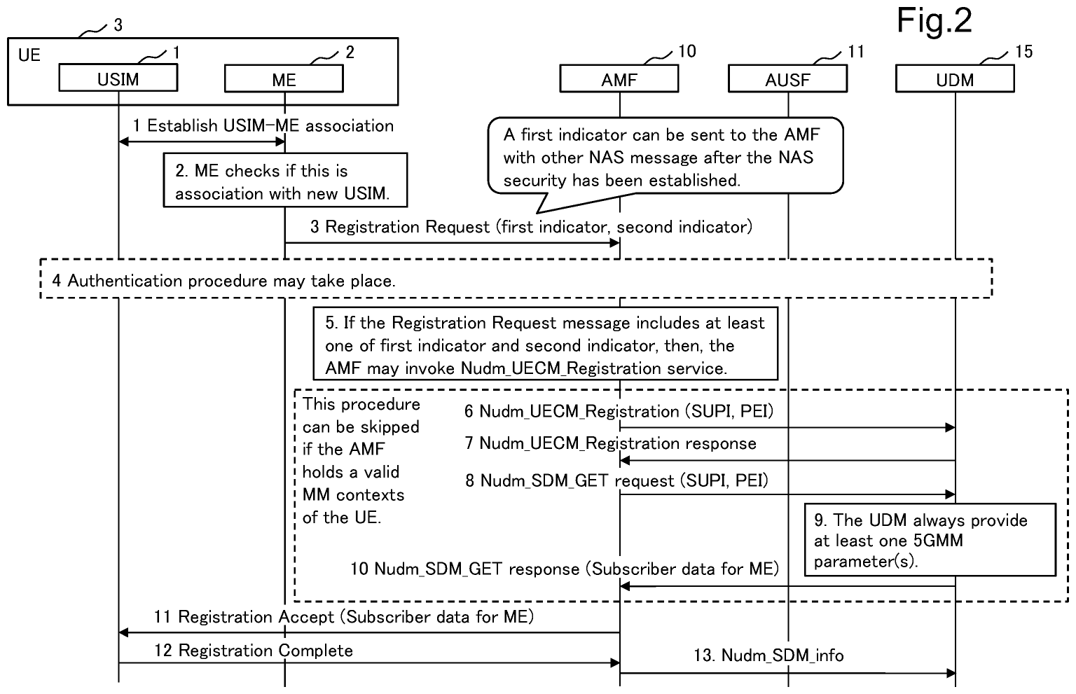

In one example, the AMF may perform the above step 6 in a case where the AMF receives at least one of the first indicator and the second indicator in step 3 in FIG. 2.

In one example, the AMF may perform the above step 6 in a case where the AMF does not receive at least one of the first indicator and the second indicator in step 3 in FIG. 2. That is, the AMF may perform the above step 6 regardless of receiving at least one of the first indicator and the second indicator. For example, the AMF may perform the above step 6 in a case where the AMF receives a registration request message which does not include the first indicator and the second indicator, or after any new or existing NAS message, for example Security Mode Complete message, or after the NAS security has been established by the authentication procedure. And then the AMF may perform processes according to FIG. 2. In addition, the UDM may always perform the above step 9 in a case where the UDM receives the Nudm_Registration message of step 6 in FIG. 2 or the Nudm_SDM_GET request message of step 8 in FIG. 2. In other words, the UDM may perform the above step 9 regardless of change of the association the PEI and the SUPI or swapping the USIM. And then the UDM may perform processes according to FIG. 2.

According to procedure as mentioned above, the UE sends at least one of the first indicator and the second indicator if the first USIM is inserted again, and the network (e.g. the AMF and the UDM) sends 5GMM parameter(s) for the first USIM to the UE.

As the consequence, the UE can receive the 5GMM parameter(s) for the first USIM and store them.

Hence, the UE can receive some subscribed services based on the 5GMM parameter(s) for the first USIM. In addition, 5GMM parameter(s) and PEI-SUPI association can synchronize between the UE and the network (e.g. the AMF and the UDM).

Further, the UE can receive the CAG information as one of the 5GMM parameter(s), hence the UE can find a CAG cell(s) for which the user has subscription and therefore can register to the PNI-NPN.

In this situation, the UE can access to the PNI-NPN.

### Third Example Embodiment Solving Problem Description (Solution 3: Network Finds PEI-SUPI Association Change)

During registration procedure (e.g. initial registration procedure), the AMF determines whether the PEI-SUPI association has changed. When the AMF receives the Registration Request message or any NAS message containing a PEI of the UE (e.g. a PEI of the ME in the UE), the AMF compares the received PEI with a PEI of the UE contexts stored in the AMF. If the received PEI from the UE matches the PEI of any stored UE context and the SUPI of the matched UE context is different from the SUPI in the UE context that corresponds to the received Registration Request message or any NAS message, the AMF sends a signalling message to the network indicating the PEI-SUPI association has been changed. The UDM upon receiving the signalling message sends at least one 5GMM parameter(s) to the AMF. The AMF includes the 5GMM parameter(s) in the Registration Accept message to the UE. The UE receives the Registration Accept message and stores the 5GMM parameter(s) and uses them in the related subsequent procedure.

The detailed steps of the procedure are defined below:

1. A first USIM is activated in a ME. For example, when the first USIM is inserted to the ME, the first USIM is activated in the ME. The ME creates association with PEI of the ME and SUPI of the first USIM, and stores the association.

2. The UE initiates registration procedure to a network (e.g. an AMF) by sending Registration Request message. For example the UE initiates initial registration procedure by sending Registration Request message.

3. Upon reception of the Registration Request message, the AMF may initiate authentication procedure. The PEI of the ME (e.g. the PEI of the ME in the UE) and the SUPI of the first USIM may be sent from the UE to the AMF by any new or existing NAS message, for example Security Mode Complete message, after the NAS security has been established by the authentication procedure.

The AMF stores PEI-SUPI association (e.g. association of PEI corresponding to the ME and SUPI corresponding to the first USIM).

4-5. After the successful authentication procedure, the AMF determines whether the PEI-SUPI association has changed for the ME. When the AMF receives the Registration Request message or any NAS message containing a PEI of the ME (e.g. the ME of the UE), the AMF compares the received PEI with a PEI of the UE contexts stored in the AMF. If the received PEI in the Registration Request message or any NAS message from the UE matches the PEI of any stored UE context in the AMF, the AMF compares a SUPI corresponding to the matched PEI in UE context stored in the AMF with a SUPI corresponding to the received PEI in the UE context that corresponds to the Registration Request message or any NAS message. If the SUPI in UE context stored in the AMF is different from the SUPI in the UE context that corresponds to the Registration Request message or any NAS message, the AMF determines that the PEI-SUPI association has been changed or swapping USIM occurs. Then the AMF sends Nudm_UECM_Registration message to the UDM. The Nudm_UECM_Registration message includes SUPI, PEI, and first indicator. For example the SUPI included in Nudm_UECM_Registration message is a SUPI corresponding to the first USIM, and the PEI included in Nudm_UECM_Registration message is a PEI corresponding to the ME. The first indicator (e.g. USIM update indicator) indicates that the PEI-SUPI association has changed in the ME. The first indicator may indicate that swapping USIM occurs.

For example, the AMF stores first association of a PEI of a ME and a first SUPI of the first USIM after the first USIM is inserted to the ME of the UE and the UE sends a first Registration Request message triggered by the insertion of the first USIM and successful authentication of the UE. After that, if a second USIM is inserted to the ME and the UE sends Registration Request message triggered by the insertion of the second USIM. In this case, after successful authentication, the AMF obtains second association of the PEI of the ME and a second SUPI of the second USIM. And then, the AMF compares the PEI of the second association with the PEI of the first association stored in the AMF. In this case, the AMF determines that the PEI is same between the first association and the second association. And then the AMF compares the first SUPI of the first association with the second SUPI of the second association. In this case, the AMF determines that the first SUPI is different from the second SUPI (that is, the AMF determines that the PEI is same but the SUPIs are different each other hence the AMF determines that the PEI-SUPI association has changed or that swapping USIM occurs). And then the AMF sends, to the UDM, the Nudm_UECM_Registration message including the first SUPI, the PEI, and the first indicator.

Otherwise (e.g. if the AMF has UE context (e.g. 5GMM parameter(s)) corresponding to the PEI or the SUPI that corresponds to the received Registration Request message or any NAS message, and the AMF determines that the PEI-SUPI association has not changed or that swapping USIM does not occur), step 5 to step 10 can be skipped and the process proceeds to step 10. The first indicator can be named as PEI-SUPI association change indicator or any other name.

6. In response of the Nudm_UECM_Registration message the UDM sends Nudm_UECM_Registration response message to the AMF.

7. The AMF sends Nudm_SDM_GET request message to the UDM. The Nudm_SDM_GET request message includes SUPI, PEI, the first indicator. For example the SUPI included in Nudm_SDM_GET request message is a SUPI corresponding to the first USIM, and the PEI included in Nudm_SDM_GET request message is a PEI corresponding to the ME.

8-9. Upon reception of Nudm_SDM_GET request message, the UDM sends, to the AMF, Nudm_SDM_GET response message containing at least one 5GMM parameter if the Nudm_SDM_GET request message or Nudm_UECM_Registration message contains the first indicator.

If the UDM provides a reporting event service for change of PEI-SUPI association, the UDM notifies new PEI-SUPI association to service consumers. The service consumer can be NEF, AF or any other entity. For example, when the UDM receives the first indicator in the Nudm_UECM_Registration message or the Nudm_SDM_GET request message, the UDM notifies new PEI-SUPI association (e.g. association of PEI corresponding to the ME and SUPI corresponding to the first USIM) to service consumers. The UDM may store the PEI-SUPI association (e.g. association of PEI corresponding to the ME and SUPI corresponding to the first USIM).

10. Upon reception of the Nudm_SDM_GET response message from the UDM, the AMF sends Registration Accept message containing the 5GMM parameter(s). The 5GMM parameter(s) can be the one received in the Nudm_SDM_GET response message from the UDM (step 9) or stored in the AMF in MM context for the UE (Step 4).

11. Upon reception of the Registration Accept message containing the 5GMM parameter(s) from the AMF, the UE sends Registration Complete message to the AMF. The UE stores the 5GMM parameter(s) and uses them in the related subsequent procedure. For example, the UE sends the Registration Complete message to acknowledge reception of the 5GMM parameter(s).

12. Upon reception of the Registration Complete message from the UE, the AMF sends, to the UDM, a message indicating successful delivery of the 5GMM parameter(s). The message may be Nudm_SDM_info message.

According to procedure as mentioned above, the AMF determines that the PEI-SUPI association has changed or that swapping USIM occurs, and the network (e.g. the AMF and the UDM) sends 5GMM parameter(s) for the first USIM to the UE.

As the consequence, the UE can receive the 5GMM parameter(s) for the first USIM and store them.

Hence, the UE can receive some subscribed services based on the 5GMM parameter(s) for the first USIM. In addition, 5GMM parameter(s) and PEI-SUPI association can synchronize between the UE and the network (e.g. the AMF and the UDM).

Further, the UE can receive the CAG information as one of the 5GMM parameter(s), hence the UE can find a CAG cell(s) for which the user has subscription and therefore can register to the PNI-NPN.

In this situation, the UE can access to the PNI-NPN.

### <Variant 1 of the Solution 3>

The variant 1 uses Equipment Identity Register (EIR) to detect PEI-SUPI association change. The EIR may be 5G-EIR. In this variant 1, the EIR maintains (or stores) association of PEI and SUPI (the PEI-SUPI association). During registration procedure (e.g. initial registration procedure), the AMF sends, to the EIR, a message containing PEI of the ME (e.g. PEI of the ME in the UE) and SUPI of USIM inserted to the ME of the UE that initiates the registration procedure. If the EIR does not have a context for the PEI, then the EIR stores the PEI-SUPI association and time information when that association is made. The time information may be called as time data. If the EIR has an entry for the PEI (that is, if the EIR has a context for the PEI), then the EIR checks whether the SUPI received in the message is different from the SUPI that is associated with the PEI stored in the EIR. If these two SUPIs are different then the EIR sends, to the AMF, PEI-SUPI association change indicator in a response message, otherwise the EIR sends, to the AMF, an indicator indicating that PEI-SUPI association remains the same in the response message.

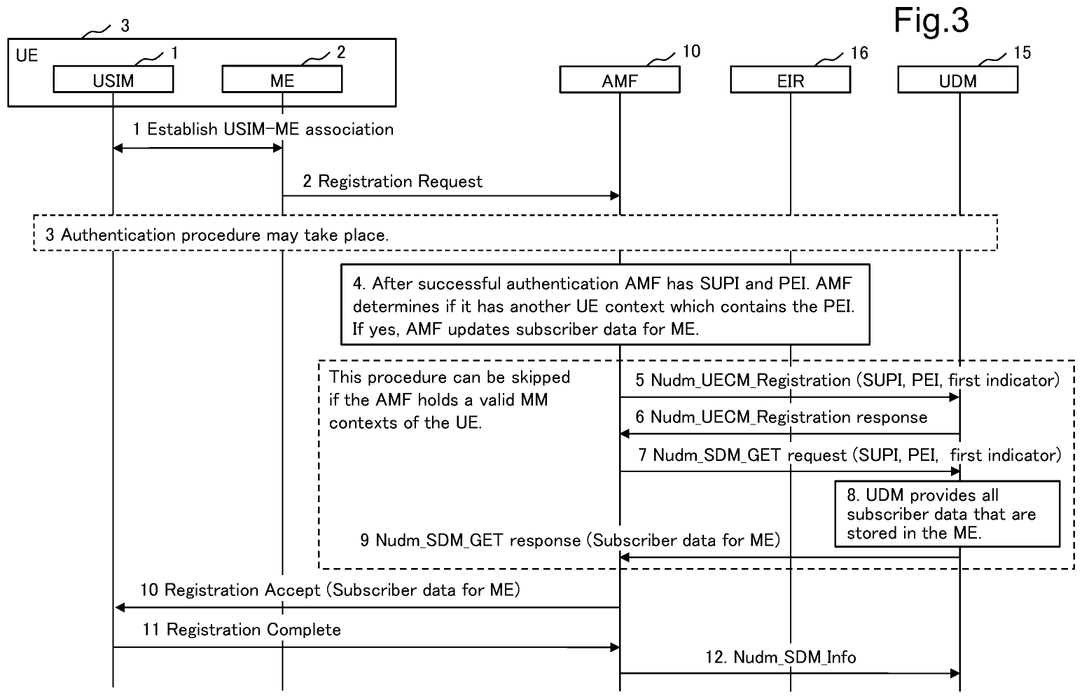

The following step 4-1 to step 4-4 may take place as the step 4 in the FIG. 3 of the Third example embodiment. For example, the step 4-1 to the step 4-4 may take place instead of the step 4.

4-1. The AMF sends N5g-eir_EquipmentIdentityCheck_Get message to the EIR. The N5g-eir_EquipmentIdentityCheck_Get message includes PEI and SUPI. The PEI and the SUPI included in N5g-eir_EquipmentIdentityCheck_Get message are a PEI and a SUPI that may be sent from the UE to the AMF by any new or existing NAS message, for example Security Mode Complete message, after the NAS security has been established by the authentication procedure, as mentioned in step 3 of the Third example embodiment.

4-2. Upon reception of the N5g-eir_EquipmentIdentityCheck_Get message, the EIR checks whether the EIR has a context for the received PEI. If the EIR does not have a context for the received PEI (e.g. association of the PEI and the SUPI received in step 4-1), then the EIR creates a context for the PEI and stores the PEI-SUPI association (e.g. association of the PEI and the SUPI received in step 4-1). The EIR optionally stores the time record when the association is created.

For example, when the EIR receives the N5g-eir_EquipmentIdentityCheck_Get message containing the PEI and the SUPI, the EIR determines whether the received PEI matches a PEI of PEI-SUPI association stored previously in the EIR. If the EIR determines that the received PEI does not match any PEI of the PEI-SUPI association stored previously in the EIR, the EIR determines that the EIR does not have the context for the received PEI.

4-3. If the EIR has a context for the PEI (e.g. the PEI-SUPI association for the received PEI), then the EIR checks whether the SUPI received in the N5g-eir_EquipmentIdentityCheck_Get message matches the SUPI that is associated with the PEI stored in the EIR.

For example, when the EIR receives the N5g-eir_EquipmentIdentityCheck_Get message containing the PEI and the SUPI, the EIR determines whether the received PEI matches a PEI of PEI-SUPI association stored previously in the EIR. If the EIR determines that the received PEI matches the PEI of the PEI-SUPI association stored previously in the EIR, the EIR determines that the EIR has the context for the received PEI.

In addition, for example, when the EIR checks whether the SUPI received in the N5g-eir_EquipmentIdentityCheck_Get message matches the SUPI that is associated with the PEI stored in the EIR, the EIR may check whether the SUPI received in the N5g-eir_EquipmentIdentityCheck_Get message is different from the SUPI that is associated with the PEI stored in the EIR.

For example, the EIR determines whether the received SUPI matches a SUPI of the PEI-SUPI association (this association includes the above matched PEI) stored previously in the EIR.

If these two SUPIs (e.g. the SUPI received in the N5g-eir_EquipmentIdentityCheck_Get message and the SUPI that is associated with the PEI stored in the EIR) are different, the EIR determines that the PEI-SUPI association has changed or that swapping USIM occurs. Then the EIR indicates PEI-SUPI association change indicator to the AMF. The indicator indicates that the PEI-SUPI association has changed. The indicator may indicate that swapping USIM occurs. For example, the EIR sends, to the AMF, the N5g-eir_EquipmentIdentityCheck_Get response message including the PEI-SUPI association change indicator.

Otherwise (e.g. if these two SUPIs are same) the EIR sends an indicator indicating that PEI-SUPI association remains the same in the N5g-eir_EquipmentIdentityCheck_Get response message. In one example the response message is sent from the EIR only when the EIR determines that the PEI-SUPI association has changed. The N5g-eir_EquipmentIdentityCheck_Get response optionally contains previously associated SUPI with the PEI and time data when the association of the PEI and previously stored SUPI made. For example, the EIR sends, to the AMF, PEI checking results indicating that PEI-SUPI association remains the same in the N5g-eir_EquipmentIdentityCheck_Get response message.

The PEI-SUPI association change indicator may be a previously associated SUPI with the PEI. For example, The PEI-SUPI association change indicator may indicate the SUPI previously associated with the PEI stored in the EIR. For example, when association of the PEI and first SUPI is changed to association of the PEI and second SUPI, the PEI-SUPI association change indicator may indicate the second SUPI.

4-4. When the AMF receives N5g-eir_EquipmentIdentityCheck_Get response message, the AMF judges (or determines or checks) whether the PEI-SUPI association has changed (or whether swapping USIM occurs) by referring information in the N5g-eir_EquipmentIdentityCheck_Get response message. For example, the AMF refers to the PEI-SUPI association change indicator. In addition, for example, when the AMF receives the PEI-SUPI association change indicator indicating that the PEI-SUPI association has changed, the AMF performs step 5 in the Third example embodiment (that is, the AMF sends the Nudm_UECM_Registration message to the UDM). Further, when the AMF receives the PEI-SUPI association change indicator indicating the SUPI previously associated with the PEI, the AMF determines that the PEI-SUPI association has changed by determining that the SUPI indicated by the PEI-SUPI association change indicator is different from the received SUPI which is mentioned in step 3 of the Third example embodiment.

In one example for the Variant 1 of the solution 3, the AMF subscribes to the PEI-SUPI association change monitor service that the EIR provides. In this AMF example, the sends N5g-eir_EquipmentIdentityMonitor message with the PEI that is received by the NAS message from the UE. The EIR notifies to the AMF whenever PEI-SUPI association is changed. The EIR notification message contains PEI, PEI-SUPI association change indicator and optionally new associated SUPI.

Upon reception of the notification on PEI-SUPI association change, the AMF can take one of following actions:
AMF keeps (or stores) the PEI-SUPI association change indicator in the MM contexts of the SUPI. Thereafter whenever the UE contacts to the AMF, the AMF shall updates the 5GMM parameter(s) in the UE.
AMF purges the SUPI.
AMF sends the De-registration request message to the UE with Re-registration. Upon reception of the De-registration request message, the UE sends the Registration request message to the AMF so that 5GMM parameter(s) in the UE can be re-installed.

### <Variant 2 of the Solution 3>

The variant 2 uses the EIR to detect PEI-SUPI association change. In this variant 2, the UDM sends a request to store the PEI-SUPI association to EIR. The EIR maintains (or stores) the PEI-SUPI association. The EIR also indicates whether the PEI-SUPI association has changed or not.

The following step 8-1 to step 8-4 may take place as the step 8 in the FIG. 3 of the Third example embodiment. For example, the UDM performs the step 8-1 to the step 8-4 in a case where the UDM receives the SUPI, the PEI and the first indicator in step 5 or 7 in FIG. 3. For example, the UDM performs the step 8-1 to the step 8-4 in a case where the UDM does not receive the first indicator in step 5 or 7 in FIG. 3. That is, the UDM may perform the step 8-1 to the step 8-4 in a case where the UDM receives the SUPI and the PEI in step 5 or 7 in FIG. 3. For example, the UDM may perform the step 8-1 to step 8-4 regardless whether the first indicator is included in Nudm_UECM_Registration message or Nudm_SDM_GET request message.

8-1. The UDM sends N5g-eir_EquipmentIdentityCheck_Get message to the EIR. The N5g-eir_EquipmentIdentityCheck_Get message includes PEI and SUPI. The PEI and the SUPI included in N5g-eir_EquipmentIdentityCheck_Get message are a PEI and a SUPI that the UDM receives in step 5 or 7 of the Third example embodiment.

8-2. Upon reception of the N5g-eir_EquipmentIdentityCheck_Get message, the EIR checks whether the EIR has a context for the received PEI. If the EIR does not have a context for the PEI (e.g. association of the PEI and the SUPI received in step 8-1), then the EIR creates a context for the PEI and stores the PEI-SUPI association (e.g. association of the PEI and the SUPI received in step 8-1). The EIR optionally stores the time record when the association is created.

For example, when the EIR receives the N5g-eir_EquipmentIdentityCheck_Get message containing the PEI and the SUPI, the AMF determines whether the received PEI matches a PEI of PEI-SUPI association stored previously in the EIR. If the EIR determines that the received PEI does not match any PEI of the PEI-SUPI association stored previously in the EIR, the EIR determines that the EIR does not have the context for the received PEI.

8-3. If the EIR has a context for the received PEI and the PEI-SUPI association for the received PEI, then the EIR checks whether the SUPI received in the N5g-eir_EquipmentIdentityCheck_Get message matches the SUPI that is associated with the PEI stored in the EIR.

For example, when the EIR receives the N5g-eir_EquipmentIdentityCheck_Get message containing the PEI and the SUPI, the EIR determines whether the received PEI matches a PEI of PEI-SUPI association stored previously in the EIR. If the EIR determines that the received PEI matches the PEI of the PEI-SUPI association stored previously in the EIR, the EIR determines that the EIR has the context for the received PEI.

In addition, for example, when the EIR checks whether the SUPI received in the N5g-eir_EquipmentIdentityCheck_Get message matches the SUPI that is associated with the PEI stored in the EIR, the EIR may check whether the SUPI received in the N5g-eir_EquipmentIdentityCheck_Get message is different from the SUPI that is associated with the PEI stored in the EIR.

For example, the EIR determines whether the received SUPI matches a SUPI of the PEI-SUPI association (this association includes the above matched PEI) stored previously in the EIR.

If these two SUPIs (e.g. the SUPI received in the N5g-eir_EquipmentIdentityCheck_Get message and the SUPI that is associated with the PEI stored in the EIR) are different, the EIR determines that the PEI-SUPI association has changed or that swapping USIM occurs. Then the EIR indicates PEI-SUPI association change indicator to the UDM. The indicator indicates that the PEI-SUPI association has changed. The indicator may indicate that swapping USIM occurs. For example, the EIR sends, to the UDM, the N5g-eir_EquipmentIdentityCheck_Get response message including the PEI-SUPI association change indicator.

Otherwise (e.g. if these two SUPIs are same) the EIR sends an indicator indicating that PEI-SUPI association remains the same in the N5g-eir_EquipmentIdentityCheck_Get response message. In one example the response message is sent from the EIR only when the EIR determines that the PEI-SUPI association has changed. The N5g-eir_EquipmentIdentityCheck_Get response optionally contains previously associated SUPI with the PEI and time data when the association of the PEI and previously stored SUPI made. For example, the EIR sends, to the UDM, PEI checking results indicating that PEI-SUPI association remains the same in the N5g-eir_EquipmentIdentityCheck_Get response message.

The PEI-SUPI association change indicator may be a previously associated SUPI with the PEI. For example, the PEI-SUPI association change indicator may indicate the previously associated SUPI with the PEI stored in the EIR. For example, when association of the PEI and first SUPI is changed to association of the PEI and second SUPI, the PEI-SUPI association change indicator may indicate the second SUPI.

8-4. When the UDM receives N5g-eir_EquipmentIdentityCheck_Get response message, the UDM judges (or determines or checks) whether the PEI-SUPI association has changed (or whether swapping USIM occurs) by information in the N5g-eir_EquipmentIdentityCheck_Get referring response message. For example, the UDM refers to the PEI-SUPI association change indicator. In addition, for example, when the UDM receives the PEI-SUPI association change indicator indicating that the PEI-SUPI association has changed, the UDM performs step 9 in the Third example embodiment (that is, the UDM sends the Nudm_SDM_GET response message to the AMF). Further, when the UDM receives the PEI-SUPI association change indicator indicating the SUPI previously associated with the PEI, the UDM determines that the PEI-SUPI association has changed by determining that the SUPI indicated by the PEI-SUPI association change indicator is different from the received SUPI which is mentioned in step 5 or 7 of the Third example embodiment.

In one example for the Variant 2 of the solution 3, the UDM subscribes to the PEI-SUPI association change monitor service that the EIR provides. In this example, the UDM sends N5g-eir_EquipmentIdentity Monitor message with the PEI that is received by the NAS message from the UE. The EIR notifies to the UDM whenever PEI-SUPI association is changed. The EIR notification message contains PEI, PEI-SUPI association change indicator and optionally new associated SUPI.

Upon reception of the notification on PEI-SUPI association change, the UDM can take one of following actions:
UDM keeps (or stores) the PEI-SUPI association change indicator in the subscriber data of the SUPI. Thereafter whenever the AMF contacts to the UDM, the UDM shall provide the 5GMM parameter(s) in the UE.
UDM notifies new PEI-SUPI association to service consumers. The service consumer can be NEF, AF or any other entity.
UDM sends the Nudm_UECM_Update to the service consumers indicating that PEI becomes invalid.
UDM sends the Nudm_SDM_Notification to the service consumers indicating that PEI becomes invalid.

In one example for the Variant 2 of the solution 3, the UDM may perform the above step 8-1 in a case where the UDM receives the first indicator in step 5 or step 7 in FIG. 3.

In one example for the Variant 2 of the solution 3, the UDM may perform the above step 8-1 in a case where the UDM does not receive the first indicator in step 5 or step 7 in FIG. 3. That is, the UDM may perform the above step 8-1 regardless of receiving the first indicator.

In the above example embodiments, the PEI-SUPI association or the association of the PEI and the SUPI may be called as association information indicating association of the PEI and SUPI, association of PEI and SUPI related to the UE.

In the above example embodiments, the 5GMM parameter(s) may be called as parameter(s) related to 5GMM or information related to 5GMM or 5GMM parameter(s) related to the UE.

In the above example embodiments, the PEI and the SUPI may be called as the PEI related to the UE and the SUPI related to the UE respectively.

In the above example embodiments, the UE, the AMF, the UDM, and the EIR may be called as a communication apparatus or communication node. In addition, the AMF, the UDM and the EIR may be called as a core network apparatus or a core network node.

In the above example embodiments, the USIM may be called as SIM.

The above example embodiments describe the PEI-SUPI association change due to swapping the USIM.

However, the example embodiments are applicable to an embedded SIM (eSIM). For example, when one USIM is activated instead of another USIM on eSIM (for example, when first configuration information for receiving services from one telecommunications carrier is activated instead of second configuration information for receiving services from another telecommunications carrier on eSIM. In this case, when the first configuration information is activated or after the first configuration information is activated, the second configuration information is deleted from eSIM), the UE may perform step 3 of the First example embodiment, or the UE may perform step 3 of the Second example embodiment or the UE may perform step 2 of the Third example embodiment. After these processes by the UE, the subsequent processes are performed according to each example embodiment.

### <User Equipment (UE)>

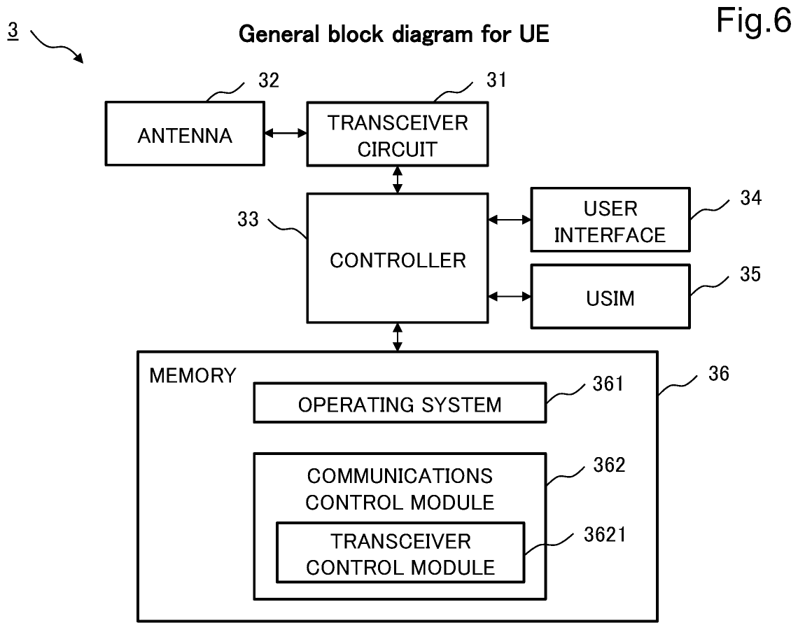

FIG. 6 is a block diagram illustrating the main components of the UE 3 (mobile device 3). As shown, the UE 3 includes a transceiver circuit 31 which is operable to transmit signals to and to receive signals from the connected node(s) via one or more antennas 32. Although not necessarily shown in the FIG. 6, the UE 3 may have all the usual functionality of a conventional mobile device (such as a user interface 34) and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 are equipped, the controller 33 may activate only one USIM 35 or may activate multiple USIMs 35 at the same time. The UE 3 may, for example, support the Non-Public Network (NPN), the NPN may be a Stand-alone Non-Public Network (SNPN) or a Public Network Integrated NPN (PNI-NPN). The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.). The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.). The UE 3 may, for example, be an item of information and communication equipment (for example information and communication equipment such as: electronic computer and related equipment; communication and related equipment; electronic components etc.). The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.). The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.). The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like. The UE 3 may, for example, be a wireless-equipped personal digital assistant or related equipment (such as a wireless card or module designed for attachment to or for insertion into another electronic device (for example a personal computer, electrical measuring machine)). The UE 3 may be a device or a part of a system that provides applications, services, and solutions described below, as to “internet of things (IOT)”, using a variety of wired and/or wireless communication technologies. The UE 3 may be a smart phone (e.g. iPhone (registered trademark), or an Android (registered trademark)-based phone) or a wearable device (e.g. smart glasses or a smart watch). The UE 3 may be a car, or a connected car, or an autonomous car, or a vehicle device, or a motorcycle or a V2X communication module. Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked. It will be appreciated that IoT technology can be implemented on any communication devices that can connect to a communications network for sending/receiving data, regardless of whether such communication devices are controlled by human input or software instructions stored in memory. It will be appreciated that IoT devices are sometimes also referred to as Machine-Type Communication (MTC) devices or Machine-to-Machine (M2M) communication devices or Narrow Band-IoT UE (NB-IOT UE). It will be appreciated that a UE 3 may support one or more IoT or MTC applications.

### <(R)an Node>

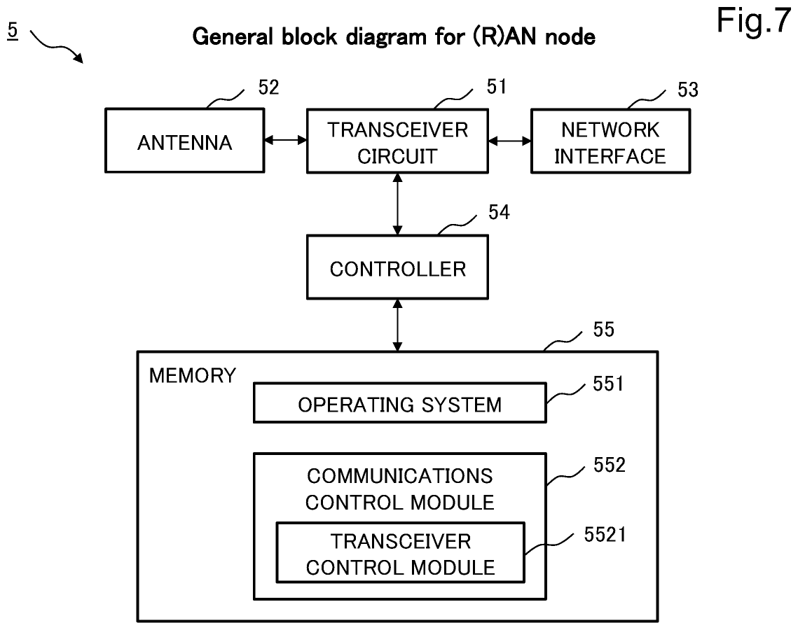

FIG. 7 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521. The communications control module 5521 (using its transceiver control sub-module) is responsible for handling (generating/sending/receiving) signalling between the (R)AN node 5 and other nodes, such as the UE 3, another (R)AN node 5, the AMF 10 and the UPF 12 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case. The controller 54 is also configured (by software or hardware) to handle related tasks such as, when implemented, UE mobility estimate and/or moving trajectory estimation. The (R)AN node 5 may support the Non-Public Network (NPN), the NPN may be a Stand-alone Non-Public Network (SNPN) or a Public Network Integrated NPN (PNI-NPN).

### <AMF>

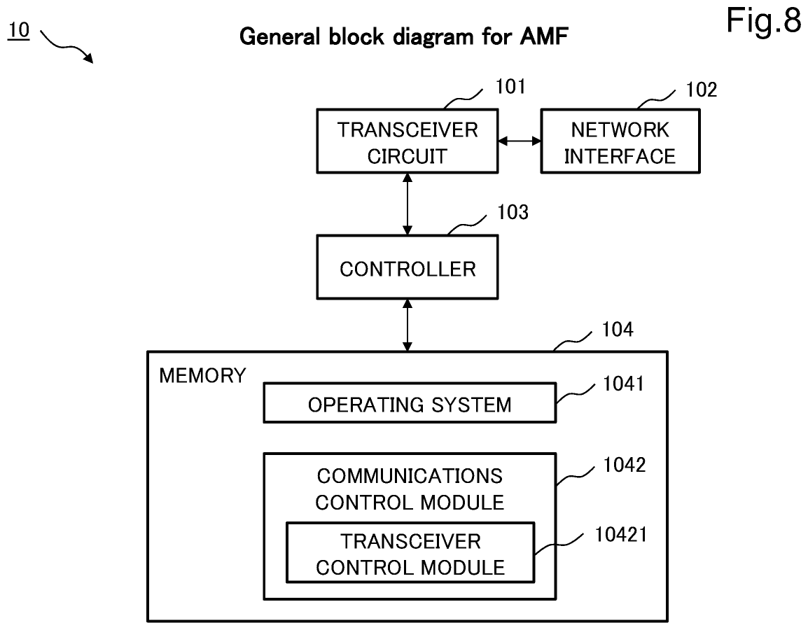

FIG. 8 is a block diagram illustrating the main components of the AMF 10. As shown, the apparatus includes a transceiver circuit 101 which is operable to transmit signals to and to receive signals from other nodes (including the UE 3) via a network interface 102. A controller 103 controls the operation of the AMF 10 in accordance with software stored in a memory 104. Software may be pre-installed in the memory 104 and/or may be downloaded via the telecommunication network or from a removable data storage device (RMD), for example. The software includes, among other things, an operating system 1041 and a communications control module 1042 having at least a transceiver control module 10421. The communications control module 1042 (using its transceiver control module 10421) is responsible for handling (generating/sending/receiving) signalling between the AMF 10 and other nodes, such as the UE 3 (e.g. via the (R)AN node 5) and other core network nodes (including core network nodes in the HPLMN of the UE 3 when the UE 3 is roaming-in). Such signalling may include, for example, appropriately formatted signalling messages (e.g. a registration request message and associated response messages) relating to access and mobility management procedures (for the UE 3). The AMF 10 may support the Non-Public Network (NPN), the NPN may be a Stand-alone Non-Public Network (SNPN) or a Public Network Integrated NPN (PNI-NPN).

### <UDM>

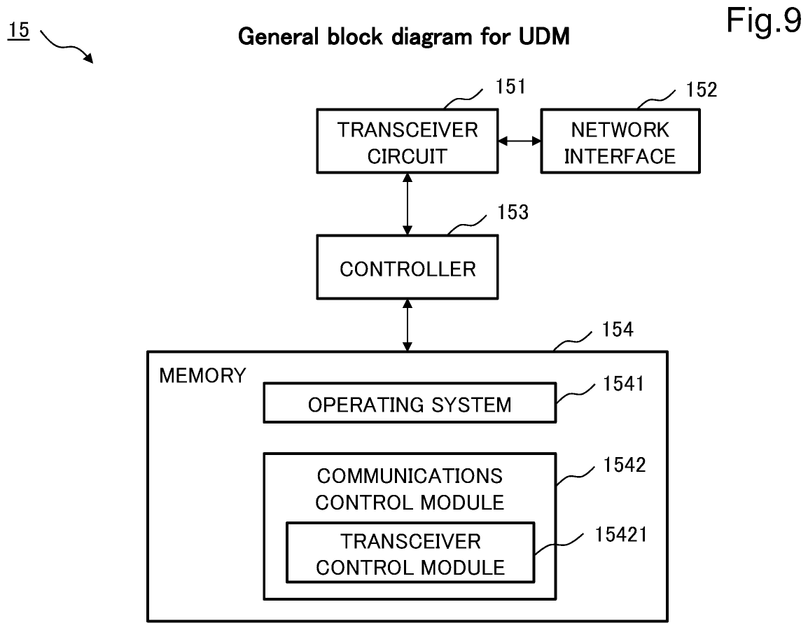

FIG. 9 is a block diagram illustrating the main components of the UDM 15. As shown, the apparatus includes a transceiver circuit 151 which is operable to transmit signals to and to receive signals from other nodes (including the AMF 10) via a network interface 152. A controller 153 controls the operation of the UDM 15 in accordance with software stored in a memory 154. Software may be pre-installed in the memory 154 and/or may be downloaded via the telecommunication network or from a removable data storage device (RMD), for example. The software includes, among other things, an operating system 1541 and a communications control module 1542 having at least a transceiver control module 15421. The communications control module 1542 (using its transceiver control module 15421) is responsible for handling (generating/sending/receiving) signalling between the UDM 15 and other nodes, such as the AMF 10 and other core network nodes (including core network nodes in the VPLMN of the UE 3 when the UE 3 is roaming-out). Such signalling may include, for example, appropriately formatted signalling messages (e.g. a HTTP restful methods based on the service based interfaces) relating to mobility management procedures (for the UE 3). The UDM 15 may support the Non-Public Network (NPN), the NPN may be a Stand-alone Non-Public Network (SNPN) or a Public Network Integrated NPN (PNI-NPN).

### <EIR>

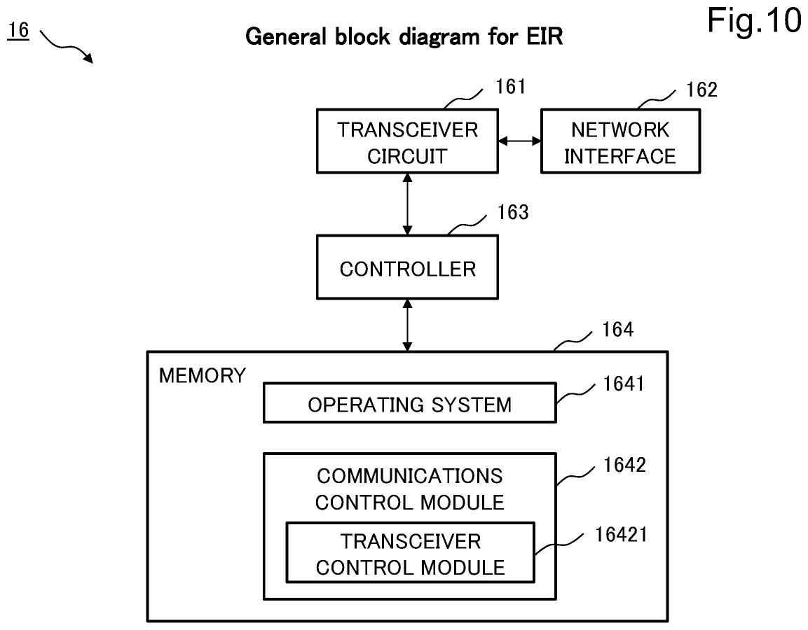

FIG. 10 is a block diagram illustrating the main components of the EIR 16. As shown, the apparatus includes a transceiver circuit 161 which is operable to transmit signals to and to receive signals from other nodes (including the AMF 10 and the UDM 15) via a network interface 162. A controller 163 controls the operation of the EIR 16 in accordance with software stored in a memory 164. Software may be pre-installed in the memory 164 and/or may be downloaded via the telecommunication network or from a removable data storage device (RMD), for example. The software includes, among other things, an operating system 1641 and a communications control module 1642 having at least a transceiver control module 16421. The communications control module 1642 (using its transceiver control module 16421) is responsible for handling (generating/sending/receiving) signalling between the EIR 16 and other nodes, such as the AMF 10, the UDM 15 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to network data analytics function procedures (for the UE 3). The EIR 16 may support the Non-Public Network (NPN), the NPN may be a Stand-alone Non-Public Network (SNPN) or a Public Network Integrated NPN (PNI-NPN).

The User Equipment (or “UE”, “mobile station”, “mobile device” or “wireless device”) in the present disclosure is an entity connected to a network via a wireless interface. It should be noted that the UE in this specification is not limited to a dedicated communication device, and can be applied to any device, having a communication function as a UE described in this specification, as explained in the following paragraphs. The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “UE” and “wireless device” also encompass devices that remain stationary for a long period of time. A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.). A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.). A UE may, for example, be an electrical application system or equipment (for example an electrical application system or equipment such as: an x-ray system; a particle accelerator; radio isotope equipment; sonic equipment; electromagnetic application equipment; electronic power application equipment etc.). A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like. A UE may, for example, be a wireless-equipped personal digital assistant or related equipment (such as a wireless card or module designed for attachment to or for insertion into another electronic device (for example a personal computer, electrical measuring machine)). A UE may be a device or a part of a system that provides applications, services, and solutions described below, as to “internet of things (IOT)”, using a variety of wired and/or wireless communication technologies. Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked. It will be appreciated that IoT technology can be implemented on any communication devices that can connect to a communications network for sending/receiving data, regardless of whether such communication devices are controlled by human input or software instructions stored in memory. It will be appreciated that IoT devices are sometimes also referred to as Machine-Type Communication (MTC) devices or Machine-to-Machine (M2M) communication devices or Narrow Band-IOT UE (NB-IOT UE). It will be appreciated that a UE may support one or more IoT or MTC applications. Some examples of MTC applications are listed in the Table 1 (source: 3GPP TS 22.368, Annex B, the contents of which are incorporated herein by reference). This list is not exhaustive and is intended to be indicative of some examples of machine type communication applications.

TABLE 1
Some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VOLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these. Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IOT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

Further, in the First to Third example embodiments and the Variants 1 and 2, the description has been given mainly of the 5G system. However, these example embodiments and the Variants may be applied also to a radio communication system other than the 5G system, e.g., 6G system, 5G beyond system, LTE system, a 3GPP UMTS (Universal Mobile Telecommunications System), a 3GPP2 CDMA2000 system (1×RTT, HRPD (High Rate Packet Data)), a GSM (Global System for Mobile Communications) system, a WiMAX system or the like.

The whole or part of the example embodiments disclosed above can be described as, but not limited to, the following supplementary notes.
supplementary note 1
A method of a user equipment (UE), the method comprising:
sending an indicator indicating that association of Permanent Equipment Identifier (PEI) and Subscription Permanent Identifier (SUPI) related to the UE is changed; and
receiving a 5GS Mobility Management (5GMM) parameter related to the UE after sending the indicator.
supplementary note 2
The method of the UE according to supplementary note 1, further comprising:
sending the indicator in a case of determining that the UE has no 5GMM parameter.
supplementary note 3
The method of the UE according to supplementary note 1, further comprising:
sending the indicator in a case of determining that the association is changed.
supplementary note 4
The method of the UE according to any one of supplementary notes 1 to 3,
wherein the indicator is included in a registration request message.
supplementary note 5
The method of the UE according to any one of supplementary notes 1 to 4,
wherein the 5GMM parameter is included in a registration accept message.
supplementary note 6
A method of an access and mobility management function (AMF), the method comprising:
receiving, from a user equipment (UE), an indicator indicating that association of Permanent Equipment Identifier (PEI) and Subscription Permanent Identifier (SUPI) related to the UE is changed;
sending the indicator to a Unified Data Management (UDM) in case of receiving the indicator from the UE;
receiving, from the UDM, a 5GS Mobility Management (5GMM) parameter related to the UE after sending the indicator; and sending, to the UE, the 5GMM parameter.
supplementary note 7
The method of the AMF according to supplementary note 6, wherein the indicator received from the UE is included in a registration request message.
supplementary note 8
The method of the AMF according to supplementary note 6 or 7,
wherein the indicator sent to the UDM is included in a Nudm_UECM_Registration message or a Nudm_SDM_GET request
supplementary note 9
The method of the AMF according to any one of supplementary notes 6 to 8,
wherein the 5GMM parameter received from the UDM is included in a Nudm_SDM_GET response message.
supplementary note 10
The method of the AMF according to any one of supplementary notes 6 to 9,
wherein the 5GMM parameter sent to the UE is included in a registration accept message.
supplementary note 11
A method of a unified data management (UDM), the method comprising:
receiving an indicator indicating that association of Permanent Equipment Identifier (PEI) and Subscription Permanent Identifier (SUPI) related to a user equipment (UE) is changed; and
sending a 5GS Mobility Management (5GMM) parameter related to the UE after receiving the indicator.
supplementary note 12
The method of the UDM according to supplementary note 11,
wherein the indicator is included in a Nudm_UECM_Registration message or a Nudm_SDM_GET request message.
supplementary note 13
A method of an access and mobility management function (AMF), the method comprising:
receiving, from a user equipment (UE), a registration request message;
sending, to a Unified Data Management (UDM), Permanent Equipment Identifier (PEI) related to the UE and Subscription Permanent Identifier (SUPI) related to the UE after receiving the registration request message;
receiving, from the UDM, a 5GS Mobility Management (5GMM) parameter related to the UE after sending the PEI and the SUPI; and
sending, to the UE, the 5GMM parameter.
supplementary note 14
The method of the AMF according to supplementary note 13, further comprising:
sending the PEI and the SUPI in a case where the registration request message includes an indicator indicating that association of the PEI and the SUPI is changed.
supplementary note 15
The method of the AMF according to supplementary note 13 or 14, wherein the PEI and the SUPI are included in a Nudm_UECM_Registration message or a Nudm_SDM_GET request message.
supplementary note 16
The method of the AMF according to any one of supplementary notes 13 to 15,
wherein the 5GMM parameter received from the UDM is included in a Nudm_SDM_GET response message.
supplementary note 17
The method of the AMF according to any one of supplementary notes 13 to 16,
wherein the 5GMM parameter sent to the UE is included in a registration accept message.
supplementary note 18
A method of a unified data management (UDM), the method comprising:
receiving Permanent Equipment Identifier (PEI) related to a user equipment (UE) and Subscription Permanent Identifier (SUPI) related to the UE; and
sending a 5GS Mobility Management (5GMM) parameter related to the UE after receiving the PEI and the SUPI.
supplementary note 19
The method of the UDM according to supplementary note 18,
wherein the PEI and the SUPI are included in a Nudm_UECM_Registration message or a Nudm_SDM_GET request message.
supplementary note 20
The method of the UDM according to supplementary note 18 or 19,
wherein the 5GMM parameter is included in a Nudm_SDM_GET response message.
supplementary note 21
A method of an access and mobility management function (AMF), the method comprising:
receiving, from a user equipment (UE), a registration request message;
determining whether association of Permanent Equipment Identifier (PEI) and Subscription Permanent Identifier (SUPI) related to the UE is changed;
sending an indicator indicating that the association is changed to a Unified Data Management (UDM) in a case of determining the association is changed;
receiving, from the UDM, a 5GS Mobility Management (5GMM) parameter related to the UE after sending the indicator; and
sending, to the UE, the 5GMM parameter.
supplementary note 22
The method of the AMF according to supplementary note 21, further comprising:
determining that the association is changed in a case where a SUPI stored in the AMF is different from the SUPI of the association.
supplementary note 23
The method of the AMF according to supplementary note 21, further comprising:
determining that the association is changed in a case of receiving, from an Equipment Identity Register (EIR), an indicator indicating that the association is changed.
supplementary note 24
A method of a unified data management (UDM), the method comprising:
determining whether association of Permanent Equipment Identifier (PEI) and Subscription Permanent Identifier (SUPI) related to a user equipment (UE) is changed; and
sending a 5GS Mobility Management (5GMM) parameter related to the UE in a case of determining the association is changed.
supplementary note 25
The method of the UDM according to supplementary note 24, further comprising:
determining that the association is changed in a case of receiving, from an Equipment Identity Register (EIR), an indicator indicating that the association is changed.
supplementary note 26
A user equipment (UE) comprising:
means for sending an indicator indicating that association of Permanent Equipment Identifier (PEI) and Subscription Permanent Identifier (SUPI) related to the UE is changed; and
means for receiving a 5GS Mobility Management (5GMM) parameter related to the UE after sending the indicator.
supplementary note 27
The UE according to supplementary note 26, further comprising:
means for sending the indicator in a case of determining that the UE has no 5GMM parameter.
supplementary note 28
The UE according to supplementary note 26, further comprising:
means for sending the indicator in a case of determining that the association is changed.
supplementary note 29
The UE according to any one of supplementary notes 26 to 28,
wherein the indicator is included in a registration request message.
supplementary note 30
The UE according to any one of supplementary notes 26 to 29,
wherein the 5GMM parameter is included in a registration accept message.
supplementary note 31
An access and mobility management function (AMF) comprising:
means for receiving, from a user equipment (UE), an indicator indicating that association of Permanent Equipment Identifier (PEI) and Subscription Permanent Identifier (SUPI) related to the UE is changed;
means for sending the indicator to a Unified Data Management (UDM) in case of receiving the indicator from the UE;
means for receiving, from the UDM, a 5GS Mobility Management (5GMM) parameter related to the UE after sending the indicator; and
means for sending, to the UE, the 5GMM parameter.
supplementary note 32
The AMF according to supplementary note 31,
wherein the indicator received from the UE is included in a registration request message.
supplementary note 33
The AMF according to supplementary note 31 or 32,
wherein the indicator sent to the UDM is included in a Nudm_UECM_Registration message or a Nudm_SDM_GET request message.
supplementary note 34
The AMF according to any one of supplementary notes 31 to 33,
wherein the 5GMM parameter received from the UDM is included in a Nudm_SDM_GET response message.
supplementary note 35
The AMF according to any one of supplementary notes 31 to 34,
wherein the 5GMM parameter sent to the UE is included in a registration accept message.
supplementary note 36
A unified data management (UDM) comprising:
means for receiving an indicator indicating that association of Permanent Equipment Identifier (PEI) and Subscription Permanent Identifier (SUPI) related to a user equipment (UE) is changed; and
means for sending a 5GS Mobility Management (5GMM) parameter related to the UE after receiving the indicator.
supplementary note 37
The UDM according to supplementary note 36,
wherein the indicator is included in a Nudm_UECM_Registration message or a Nudm_SDM_GET request message.
supplementary note 38
An access and mobility management function (AMF) comprising:
means for receiving, from a user equipment (UE), a registration request message;
means for sending, to a Unified Data Management (UDM), Permanent Equipment Identifier (PEI) related to the UE and Subscription Permanent Identifier (SUPI) related to the UE after receiving the registration request message;
means for receiving, from the UDM, a 5GS Mobility Management (5GMM) parameter related to the UE after sending the PEI and the SUPI; and
means for sending, to the UE, the 5GMM parameter.
supplementary note 39
The AMF according to supplementary note 38, further comprising:
means for sending the PEI and the SUPI in a case where the registration request message includes an indicator indicating that association of the PEI and the SUPI is changed.
supplementary note 40
The AMF according to supplementary note 38 or 39,
wherein the PEI and the SUPI are included in a Nudm_UECM_Registration message or a Nudm_SDM_GET request message.
supplementary note 41
The AMF according to any one of supplementary notes 38 to 40,
wherein the 5GMM parameter received from the UDM is included in a Nudm_SDM_GET response message.
supplementary note 42
The AMF according to any one of supplementary notes 38 to 41,
wherein the 5GMM parameter sent to the UE is included in a registration accept message.
supplementary note 43
A unified data management (UDM) comprising:
means for receiving Permanent Equipment Identifier (PEI) related to a user equipment (UE) and Subscription Permanent Identifier (SUPI) related to the UE; and
means for sending a 5GS Mobility Management (5GMM) parameter related to the UE after receiving the PEI and the SUPI.
supplementary note 44
The UDM according to supplementary note 43,
wherein the PEI and the SUPI are included in a Nudm_UECM_Registration message or a Nudm_SDM_GET request message.
supplementary note 45
The UDM according to supplementary note 43 or 44,
wherein the 5GMM parameter is included in a Nudm_SDM_GET response message.
supplementary note 46
An access and mobility management function (AMF) comprising:
means for receiving, from a user equipment (UE), a registration request message;
means for determining whether association of Permanent Equipment Identifier (PEI) and Subscription Permanent Identifier (SUPI) related to the UE is changed;
means for sending an indicator indicating that the association is changed to a Unified Data Management (UDM) in a case of determining the association is changed;
means for receiving, from the UDM, a 5GS Mobility Management (5GMM) parameter related to the UE after sending the indicator; and
means for sending, to the UE, the 5GMM parameter.
supplementary note 47
The AMF according to supplementary note 46, further comprising: means for determining that the association is changed in a case where a SUPI stored in the AMF is different from the SUPI of the association.
supplementary note 48
The AMF according to supplementary note 46 or 47, further comprising:
means for determining that the association is changed in a case of receiving, from an Equipment Identity Register (EIR), an indicator indicating that the association is changed.
supplementary note 49
A unified data management (UDM) comprising:
means for determining whether association of Permanent Equipment Identifier (PEI) and Subscription Permanent Identifier (SUPI) related to a user equipment (UE) is changed; and
means for sending a 5GS Mobility Management (5GMM) parameter related to the UE in a case of determining the association is changed.
supplementary note 50
The UDM according to supplementary note 49, further comprising:
means for determining that the association is changed in a case of receiving, from an Equipment Identity Register (EIR), an indicator indicating that the association is changed.
The whole or part of the example embodiments disclosed above can be described as, but not limited to, the following.

### 4.2.2.2 Registration Procedures

### 4.2.2.2.1 General

A UE needs to register with the network to get authorized to receive services, to enable mobility tracking and to enable reachability. The UE initiates the Registration procedure using one of the following Registration types:
Initial Registration to the 5GS;
Mobility Registration Update upon changing to a new Tracking Area (TA) outside the UE's Registration Area in both CM-CONNECTED and CM-IDLE state, or when the UE needs to update its capabilities or protocol parameters that are negotiated in Registration procedure with or without changing to a new TA, a change in the UE's Preferred Network Behaviour that would create an incompatibility with the Supported Network Behaviour provided by the serving AMF, or when the UE intends to retrieve LADN Information; or
Periodic Registration Update (due to a predefined time period of inactivity); or
Emergency Registration.

The General Registration call flow in clause 4.2.2.2.2 applies on all these Registration procedures, but the periodic registration need not include all parameters that are used in other registration cases.

The following are the cleartext IEs, as defined in TS 24.501 that can be sent by the UE in the Registration Request message if the UE has no NAS security context:
Registration type
SUCI or 5G-GUTI or PEI
Security parameters
additional GUTI
4G Tracking Area Update
the indication that the UE is moving from EPS.

Aspects related to dual registration in 3GPP and non-3GPP access are described in clause 4.12. The general Registration call flow in clause 4.2.2.2.2 is also used for the case of registration in 3GPP access when the UE is already registered in a non-3GPP access, and vice versa. Registration in 3GPP access when the UE is already registered in a non-3GPP access scenario may require an AMF change, as further detailed in clause 4.12.8.

The general Registration call flow in clause 4.2.2.2.2 is also used by UEs in limited service state (see TS 23.122 [22]) registering for emergency services only (referred to as Emergency Registration), see TS 23.501 [2] clause 5.16.4.

During the initial registration the PEI is obtained from the UE. If the PEI is needed (e.g. for EIR check), the AMF shall retrieve the PEI when it establishes the NAS security context with a Security Mode Command during initial registration. The AMF operator may check the PEI with an EIR. If the PEI was retrieved by the AMF (either from the UE or another AMF), AMF shall provide it to the UDM using Nudm_UECM_Registration in order to ensure that the UDM always has the latest PEI available e.g. for reporting event Change of SUPI-PEI association. The AMF passes the PEI to the UDM, to the SMF and the PCF. The UDM may store this data in UDR by Nudr_SDM_Update.

NOTE 1: The use of NSI ID in the 5GC is optional and depends on the deployment choices of the operator.

During the registration the Home Network can provide Steering of Roaming information to the UE via the AMF (i.e. a list of preferred PLMN/access technology combinations or HPLMN indication that ‘no change of the “Operator Controlled PLMN Selector with Access Technology” list stored in the UE is needed). The Home Network can include an indication for the UE to send an acknowledgement of the reception of this information. Details regarding the handling of Steering of Roaming information including how this information is managed between the AMF and the UE are defined in TS 23.122 [22].

The AMF determines Access Type and RAT Type as defined in TS 23.501 [2] clause 5.3.2.3.

### 4.2.2.2.2 General Registration

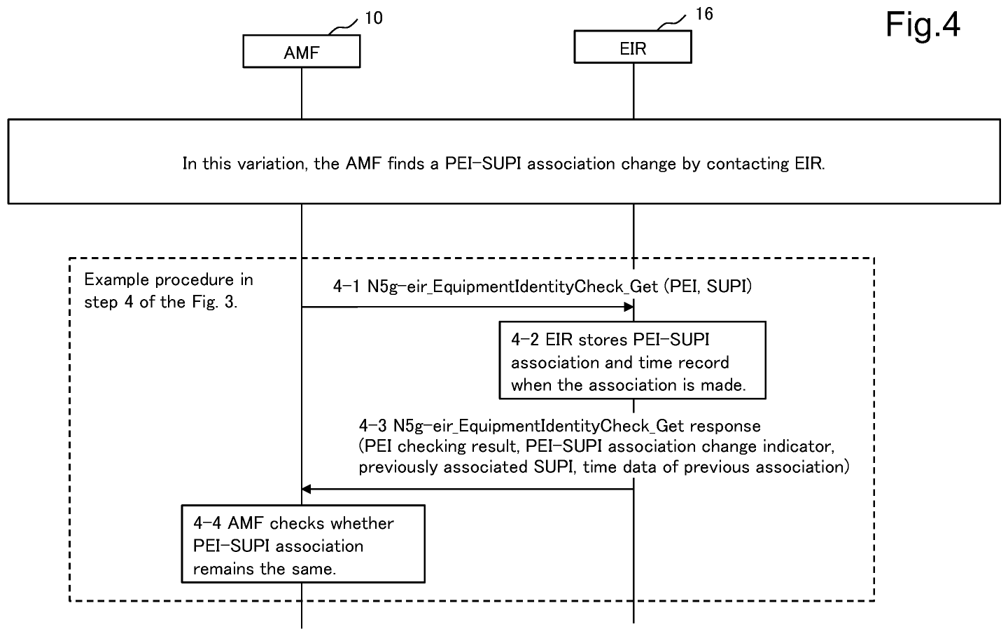

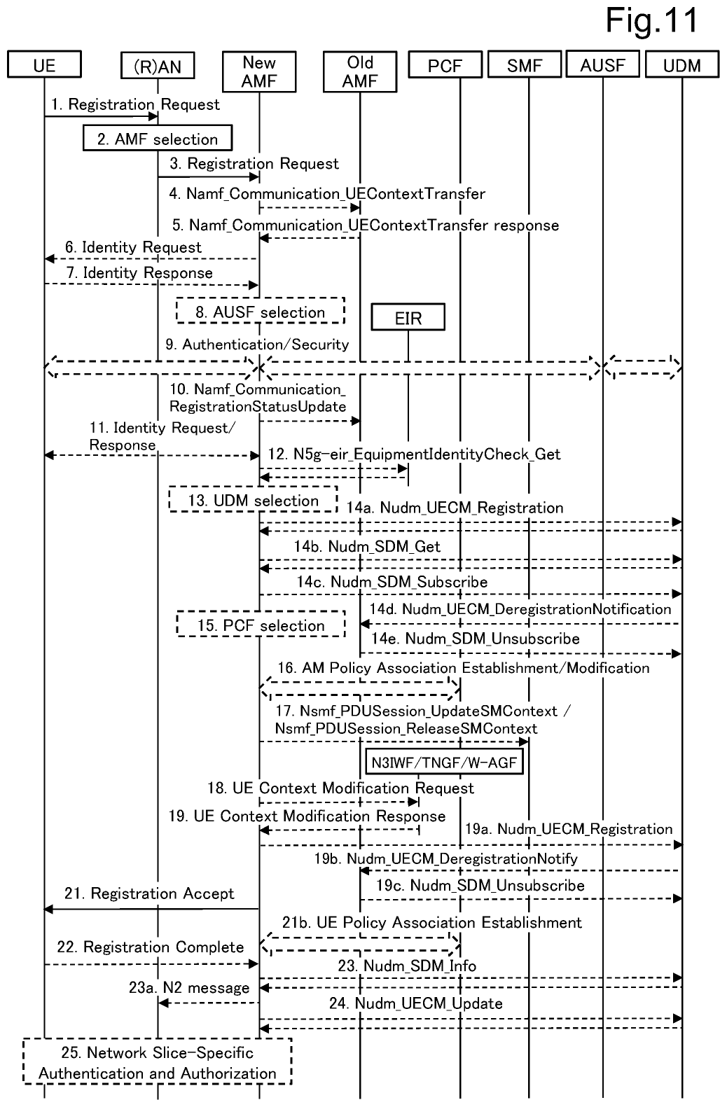

### FIG. 4.2.2.2.2-1: Registration Procedure (See FIG. 11 of the Present Application)

1. UE to (R)AN: AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IOT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [UE Policy Container (the list of PSIs, indication of UE support for ANDSP and the operating system identifier)] and [UE Radio Capability ID], PEI. PEI-SUPI association change indicator)).

NOTE 1: The UE Policy Container and its usage is defined in TS 23.503 [20].

In the case of NG-RAN, the AN parameters include e.g. 5G-S-TMSI or GUAMI, the Selected PLMN ID (or PLMN ID and NID, see TS 23.501 [2], clause 5.30) and NSSAI information, the AN parameters also include Establishment cause. The Establishment cause provides the reason for requesting the establishment of an RRC connection. Whether and how the UE includes the NSSAI information as part of the AN parameters is dependent on the value of the Access Stratum Connection Establishment NSSAI Inclusion Mode parameter, as specified in clause 5.15.9 of TS 23.501 [2].

The AN parameters shall also include an IAB-Indication if the UE is an IAB-node accessing 5GS.

The Registration type indicates if the UE wants to perform an Initial Registration (i.e. the UE is in RM-DEREGISTERED state), a Mobility Registration Update (i.e. the UE is in RM-REGISTERED state and initiates a Registration procedure due to mobility or due to the UE needs to update its capabilities or protocol parameters, or to request a change of the set of network slices it is allowed to use), a Periodic Registration Update (i.e. the UE is in RM-REGISTERED state and initiates a Registration procedure due to the Periodic Registration Update timer expiry, see clause 4.2.2.2.1) or an Emergency Registration (i.e. the UE is in limited service state).

When the UE is using E-UTRA, the UE indicates its support of CIoT 5GS Optimisations, which is relevant for the AMF selection, in the RRC connection establishment signalling associated with the Registration Request.

When the UE is performing an Initial Registration the UE shall indicate its UE identity in the Registration Request message as follows, listed in decreasing order of preference in the case of registration with a PLMN:
i) a 5G-GUTI mapped from an EPS GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.
NOTE 2: This can also be a 5G-GUTIs assigned via another access type.
v) Otherwise, the UE shall include its SUCI in the Registration Request as defined in TS 33.501 [15].

When the UE performing an Initial Registration has both a valid EPS GUTI and a native 5G-GUTI, the UE shall also indicate the native 5G-GUTI as Additional GUTI. If more than one native 5G-GUTIs are available, the UE shall select the 5G-GUTI in decreasing order of preference among items (ii)-(iv) in the list above.

When registering with an SNPN with 5G-GUTI as UE identity, the UE shall only use the 5G-GUTI previously assigned by the same SNPN.

The NAS message container shall be included if the UE is sending a Registration Request message as an Initial NAS message and the UE has a valid 5G NAS security context and the UE needs to send non-cleartext IEs, see clause 4.4.6 in TS 24.501 [25]. If the UE does not need to send non-cleartext IEs, the UE shall send a Registration Request message without including the NAS message container.

If the UE does not have a valid 5G NAS security context, the UE shall send the Registration Request message without including the NAS message container. The UE shall include the entire Registration Request message (i.e. containing cleartext IEs and non-cleartext IEs) in the NAS message container that is sent as part of the Security Mode Complete message in step 9b.

When the UE is performing an Initial Registration (i.e., the UE is in RM-DEREGISTERED state) with a native 5G-GUTI then the UE shall indicate the related GUAMI information in the AN parameters. When the UE is performing an Initial Registration with its SUCI, the UE shall not indicate any GUAMI information in the AN parameters.

When the UE is performing an Initial Registration or a Mobility Registration and if CIOT 5GS Optimisations are supported the UE shall indicate its Preferred Network Behaviour (see TS 23.501 [2] clause 5.31.2). If S1 mode is supported the UE's EPC Preferred Network Behaviour is included in the S1 UE network capabilities in the Registration Request message, see TS 24.501 [25], clause 8.2.6.1.

For an Emergency Registration, the SUCI shall be included if the UE does not have a valid 5G-GUTI available; the PEI shall be included when the UE has no SUPI and no valid 5G-GUTI. In other cases, the 5G-GUTI is included and it indicates the last serving AMF.

The UE may provide the UE's usage setting based on its configuration as defined in TS 23.501 [2] clause 5.16.3.7. The UE provides Requested NSSAI as described in TS 23.501 [2] clause 5.15.5.2.1, and in the case of Initial Registration or Mobility Registration Update, the UE includes the Mapping Of Requested NSSAI (if available), which is the mapping of each S-NSSAI of the Requested NSSAI to the HPLMN S-NSSAIs, to ensure that the network is able to verify whether the S-NSSAI(s) in the Requested NSSAI are permitted based on the Subscribed S-NSSAIs. In the case of inter PLMN mobility, if the serving PLMN S-NSSAI(s) corresponding to the established PDU Session(s) are not present in the UE, the associated HPLMN S-NSSAI(s) associated with the established PDU Session(s) shall be provided in the Mapping Of Requested NSSAI as described in the clause 5.15.5.2.1 TS 23.501 [2].

The UE includes the Default Configured NSSAI Indication if the UE is using a Default Configured NSSAI, as defined in TS 23.501 [2].

The UE may include UE paging probability information if it supports the assignment of WUS Assistance Information from the AMF (see TS 23.501 [2]).

In the case of Mobility Registration Update, the UE includes in the List Of PDU Sessions To Be Activated the PDU Sessions for which there are pending uplink data. When the UE includes the List Of PDU Sessions To Be Activated, the UE shall indicate PDU Sessions only associated with the access the Registration Request is related to. As defined in TS 24.501 [25] the UE shall include always-on PDU Sessions which are accepted by the network in the List Of PDU Sessions To Be Activated even if there are no pending uplink data for those PDU Sessions.

NOTE 3: A PDU Session corresponding to a LADN is not included in the List Of PDU Sessions To Be Activated when the UE is outside the area of availability of the LADN.

The UE MM Core Network Capability is provided by the UE and handled by AMF as defined in TS 23.501 [2] clause 5.4.4a. The UE includes in the UE MM Core Network Capability an indication if it supports Request Type flag “handover” for PDN connectivity request during the attach procedure as defined in clause 5.17.2.3.1 of TS 23.501 [2]. If the UE supports ‘Strictly Periodic Registration Timer Indication’, the UE indicates its capability of ‘Strictly Periodic Registration Timer Indication’ in the UE MM Core Network Capability. If the UE supports CAG, the UE indicates its capability of “CAG supported” in the UE MM Core Network Capability.

The UE may provide either the LADN DNN(s) or an Indication Of Requesting LADN Information as described in TS 23.501 [2] clause 5.6.5.

If available, the last visited TAI shall be included in order to help the AMF produce Registration Area for the UE.

The Security parameters are used for Authentication and integrity protection, see TS 33.501 [15]. Requested NSSAI indicates the Network Slice Selection Assistance Information (as defined in clause 5.15 of TS 23.501 [2]). The PDU Session status indicates the previously established PDU Sessions in the UE. When the UE is connected to the two AMFs belonging to different PLMN via 3GPP access and non-3GPP access then the PDU Session status indicates the established PDU Session of the current PLMN in the UE.

The Follow-on request is included when the UE has pending uplink signalling and the UE doesn't include List Of PDU Sessions To Be Activated, or the Registration type indicates the UE wants to perform an Emergency Registration. In Initial Registration and Mobility Registration Update, UE provides the UE Requested DRX parameters, as defined in clause 5.4.5 of TS 23.501 [2]. The UE may provide the extended idle mode DRX parameters as defined in clause 5.31.7.2 of TS 23.501 [2] to request extended idle mode DRX.

The UE provides UE Radio Capability Update indication as described in TS 23.501 [2].

The UE includes the MICO mode preference and optionally a Requested Active Time value if the UE wants to use MICO Mode with Active Time.

The UE may indicate its Service Gap Control Capability in the UE MM Core Network Capability, see TS 23.501 [2] clause 5.31.16.

For a UE with a running Service Gap timer in the UE, the UE shall not set Follow-on Request indication or Uplink data status in the Registration Request message (see TS 23.501 [2] clause 5.31.16), except for network access for regulatory prioritized services like Emergency services or exception reporting.

If UE supports RACS and has been assigned UE Radio Capability ID(s), the UE shall indicate a UE Radio Capability ID as defined in TS 23.501 [2] clause 5.4.4.1a as non-cleartext IE.

The PEI may be retrieved in initial registration from the UE as described in clause 4.2.2.2.1.

2. If a 5G-S-TMSI or GUAMI is not included or the 5G-S-TMSI or GUAMI does not indicate a valid AMF the (R)AN, based on (R)AT and Requested NSSAI, if available, selects an AMF

The (R)AN selects an AMF as described in TS 23.501 [2], clause 6.3.5. If UE is in CM-CONNECTED state, the (R)AN can forward the Registration Request message to the AMF based on the N2 connection of the UE.

If the (R)AN cannot select an appropriate AMF, it forwards the Registration Request to an AMF which has been configured, in (R)AN, to perform AMF selection.

3. (R)AN to new AMF: N2 message (N2 parameters, Registration Request (as described in step 1) and [LTE-M Indication].

When NG-RAN is used, the N2 parameters include the Selected PLMN ID (or PLMN ID and NID, see TS 23.501 [2], clause 5.30), Location Information and Cell Identity related to the cell in which the UE is camping, UE Context Request which indicates that a UE context including security information needs to be setup at the NG-RAN.

When NG-RAN is used, the N2 parameters shall also include the Establishment cause and IAB-Indication if the indication is received in AN parameters in step 1.

Mapping Of Requested NSSAI is provided only if available.

If the Registration type indicated by the UE is Periodic Registration Update, then steps 4 to 19 may be omitted.

When the Establishment cause is associated with priority services (e.g. MPS, MCS), the AMF includes a Message Priority header to indicate priority information. Other NFs relay the priority information by including the Message Priority header in service-based interfaces, as specified in TS 29.500 [17].

The RAT Type the UE is using is determined (see clause 4.2.2.2.1) and based on it the AMF determines whether the UE is performing Inter-RAT mobility to or from NB-IOT. If the AMF receives the LTE M indication, then it considers that the RAT Type is LTE-M and stores the LTE-M Indication in UE Context.

If a UE includes a Preferred Network Behaviour, this defines the Network Behaviour the UE supports and is expecting to be available in the network as defined in TS 23.501 [2], clause 5.31.2.

If the UE has included the Preferred Network Behaviour, and what the UE indicated it supports in Preferred Network Behaviour is incompatible with the network support, the AMF shall reject the Registration Request with an appropriate cause value (e.g. one that avoids retries on this PLMN).

If there is a Service Gap timer running in the UE Context in AMF for the UE, and Follow-on Request indication or Uplink data status is included in the Registration Request message, the AMF shall ignore the Follow-on Request indication and Uplink data status and not perform any of the actions related to the status.

If the UE has included a UE Radio Capability ID in step 1 and the AMF supports RACS, the AMF stores the Radio Capability ID in UE context.

For NR satellite access, if the AMF can determine based on the Selected PLMN ID and ULI (including Cell ID) received from the gNB that the UE is attempting to register to a PLMN that is not allowed to operate at the present UE location, then the AMF should reject the Registration Request indicating a suitable Cause value and, if known in AMF, the country of the UE location. Otherwise, e.g. if the AMF is not aware of the UE location with sufficient accuracy to make a final decision, the AMF proceeds with the Registration procedure and may initiate UE location procedure as specified in TS 23.273 [51], clause 6.10.1 and be prepared to deregister the UE if the information received from LMF proves that the UE is registered to a PLMN that is not allowed to operate in the UE location.

NOTE 4: The location information cannot be guaranteed to be sufficiently accurate for the AMF to determine in all cases the country where UE is located.

NOTE 5: Some countries use multiple MCCs and some MCCs, such as 901, can be allowed in multiple countries and therefore the UE can register in a PLMN with MCC different from the one returned to the UE.

Upon receiving a Registration Reject with the country in which the UE is located, the UE shall attempt to register to a PLMN that is allowed to operate at the UE location as specified in TS 23.122 [22].

4. [Conditional] new AMF to old AMF: Namf_Communication_UEContextTransfer (complete Registration Request) or new AMF to UDSF: Nudsf_Unstructured Data Management_Query( ).

(With UDSF Deployment): If the UE's 5G-GUTI was included in the Registration Request and the serving AMF has changed since last Registration procedure, new AMF and old AMF are in the same AMF Set and UDSF is deployed, the new AMF retrieves the stored UE's SUPI and UE context directly from the UDSF using Nudsf_UnstructuredDataManagement_Query service operation or they can share stored UE context via implementation specific means if UDSF is not deployed. This includes also event subscription information by each NF consumer for the given UE. In this case, the new AMF uses integrity protected complete Registration request NAS message to perform and verify integrity protection.

(Without UDSF Deployment): If the UE's 5G-GUTI was included in the Registration Request and the serving AMF has changed since last Registration procedure, the new AMF may invoke the Namf_Communication_UEContextTransfer service operation on the old AMF including the complete Registration Request NAS message, which may be integrity protected, as well as the Access Type, to request the UE's SUPI and UE Context. See clause 5.2.2.2.2 for details of this service operation. In this case, the old AMF uses either 5G-GUTI and the integrity protected complete Registration request NAS message, or the SUPI and an indication that the UE is validated from the new AMF, to verify integrity protection if the context transfer service operation invocation corresponds to the UE requested. The old AMF also transfers the event subscriptions information by each NF consumer, for the UE, to the new AMF. If the old AMF has not yet reported a non-zero MO Exception Data Counter to the (H-)SMF, the Context Response also includes the MO Exception Data Counter.

If the old AMF has PDU Sessions for another access type (different from the Access Type indicated in this step) and if the old AMF determines that there is no possibility for relocating the N2 interface to the new AMF, the old AMF returns UE's SUPI and indicates that the Registration Request has been validated for integrity protection, but does not include the rest of the UE context.

For inter PLMN mobility, UE Context information includes HPLMN S-NSSAIs corresponding to the Allowed NSSAI for each Access Type, without Allowed NSSAI of old PLMN.

NOTE 6: The new AMF Sets the indication that the UE is validated according to step 9a, if the new AMF has performed successful UE authentication after previous integrity check failure in the old AMF.

NOTE 7: The NF consumers do not need to subscribe for the events once again with the new AMF after the UE is successfully registered with the new AMF.

If the new AMF has already received UE contexts from the old AMF during handover procedure, then step 4, 5 and 10 shall be skipped.

For an Emergency Registration, if the UE identifies itself with a 5G-GUTI that is not known to the AMF, steps 4 and 5 are skipped and the AMF immediately requests the SUPI from the UE. If the UE identifies itself with PEI, the SUPI request shall be skipped. Allowing Emergency Registration without a user identity is dependent on local regulations.

5. [Conditional] old AMF to new AMF: Response to Namf_Communication_UEContextTransfer (SUPI, UE Context in AMF (as per Table 5.2.2.2.2-1)) or UDSF to new AMF: Nudsf_Unstructured Data Management_Query( ) The old AMF may start an implementation specific (guard) timer for the UE context.

If the UDSF was queried in step 4, the UDSF responds to the new AMF for the Nudsf_Unstructured Data Management_Query invocation with the related contexts including established PDU Sessions, the old AMF includes SMF information DNN, S-NSSAI(s) and PDU Session ID, active NGAP UE-TNLA bindings to N3IWF/TNGF/W-AGF, the old AMF includes information about the NGAP UE-TNLA bindings. If the Old AMF was queried in step 4, Old AMF responds to the new AMF for the Namf_Communication_UEContextTransfer invocation by including the UE's SUPI and UE Context.

If old AMF holds information about established PDU Session(s) and it is not an Initial Registration, the old AMF includes SMF information, DNN(s), S-NSSAI(s) and PDU Session ID(s).

If old AMF holds UE context established via N3IWF, W-AGF or TNGF, the old AMF includes the CM state via N3IWF, W-AGF or TNGF. If the UE is in CM-CONNECTED state via N3IWF, W-AGF or TNGF, the old AMF includes information about the NGAP UE-TNLA bindings.

If old AMF fails the integrity check of the Registration Request NAS message, the old AMF shall indicate the integrity check failure. If the new AMF is configured to allow emergency services for unauthenticated UE, the new AMF behaves as follows:
If the UE has only an emergency PDU Session, the AMF either skips the authentication and security procedure or accepts that the authentication may fail and continues the Mobility Registration Update procedure; or
If the UE has both emergency and non emergency PDU Sessions and authentication fails, the AMF continues the Mobility Registration Update procedure and deactivates all the non-emergency PDU Sessions as specified in clause 4.3.4.2.

NOTE 8: The new AMF can determine if a PDU Session is used for emergency service by checking whether the DNN matches the emergency DNN.

If old AMF holds information about AM Policy Association and the information about UE Policy Association (i.e. the Policy Control Request Trigger for updating UE Policy as defined in TS 23.503 [20]), the old AMF includes the information about the AM Policy Association, the UE Policy Association and PCF ID. In the roaming case, V-PCF ID and H-PCF ID are included.

If old AMF was a consumer of UE related NWDAF services, the old AMF includes information about active analytics subscriptions, i.e. the NWDAF identifier (i.e. Instance ID or Set ID), and associated Analytics specific data (i.e. Analytics ID(s), Analytics Filter Information, Target of Analytics reporting, Analytics Reporting Info) in the Namf_Communication_UEContextTransfer response.

Editor's note: Whether or not the old AMF includes the analytics subscription binding details, and how the new AMF uses it is FFS.

Editor's note: Whether and how the new AMF initiates a new analytics subscription using received NWDAF ID from old AMF or with new NWDAF ID, and mechanism if the new AMF is not within the NWDAF's service area is FFS.

During inter PLMN mobility, the handling of the UE Radio Capability ID in the new AMF is as defined in TS 23.501 [2].

NOTE 9: When new AMF uses UDSF for context retrieval, interactions between old AMF, new AMF and UDSF due to UE signalling on old AMF at the same time is implementation issue.

6. [Conditional] new AMF to UE: Identity Request ( ).

If the SUCI is not provided by the UE nor retrieved from the old AMF the Identity Request procedure is initiated by AMF sending an Identity Request message to the UE requesting the SUCI.

7. [Conditional] UE to new AMF: Identity Response ( ).

The UE responds with an Identity Response message including the SUCI. The UE derives the SUCI by using the provisioned public key of the HPLMN, as specified in TS 33.501 [15].

8. The AMF may decide to initiate UE authentication by invoking an AUSF. In that case, the AMF selects an AUSF based on SUPI or SUCI, as described in TS 23.501 [2], clause 6.3.4.

If the AMF is configured to support Emergency Registration for unauthenticated SUPIs and the UE indicated Registration type Emergency Registration, the AMF skips the authentication or the AMF accepts that the authentication may fail and continues the Registration procedure.

9a. If authentication is required, the AMF requests it from the AUSF; if Tracing Requirements about the UE are available at the AMF, the AMF provides Tracing Requirements in its request to AUSF. Upon request from the AMF, the AUSF shall execute authentication of the UE. The authentication is performed as described in TS 33.501 [15]. The AUSF selects a UDM as described in TS 23.501 [2], clause 6.3.8 and gets the authentication data from UDM.

Once the UE has been authenticated the AUSF provides relevant security related information to the AMF. If the AMF provided a SUCI to AUSF, the AUSF shall return the SUPI to AMF only after the authentication is successful.

After successful authentication in new AMF, which is triggered by the integrity check failure in old AMF at step 5, the new AMF invokes step 4 above again and indicates that the UE is validated (i.e. through the reason parameter as specified in clause 5.2.2.2.2).

9b If NAS security context does not exist, the NAS security initiation is performed as described in TS 33.501 [15]. If the UE had no NAS security context in step 1, the UE includes the full Registration Request message as defined in TS 24.501 [25].

The AMF decides if the Registration Request needs to be rerouted as described in clause 4.2.2.2.3, where the initial AMF refers to the AMF.

9c. The AMF initiates NGAP procedure to provide the 5G-AN with security context as specified in TS 38.413 if the 5G-AN had requested for UE Context. Also, if the AMF decides that EPS fallback is supported (e.g. based on UE capability to support Request Type flag “handover” for PDN connectivity request during the attach procedure as defined in clause 5.17.2.3.1 of TS 23.501 [2], subscription data and local policy), the AMF shall send an indication “Redirection for EPS fallback for voice is possible” towards 5G-AN as specified in TS 38.413 [10]. Otherwise, the AMF indicates “Redirection for EPS fallback for voice is not possible”. In addition, if Tracing Requirements about the UE are available at the AMF, the AMF provides the 5G-AN with Tracing Requirements in the NGAP procedure.

9d. The 5G-AN stores the security context and acknowledges to the AMF. The 5G-AN uses the security context to protect the messages exchanged with the UE as described in TS 33.501 [15].

10. [Conditional] new AMF to old AMF: Namf_Communication_RegistrationStatusUpdate (PDU Session ID(s) to be released due to slice not supported).

If the AMF has changed the new AMF informs the old AMF that the registration of the UE in the new AMF is completed by invoking the Namf_Communication_RegistrationStatusUpdate service operation.

If the authentication/security procedure fails, then the Registration shall be rejected, and the new AMF invokes the Namf_Communication_RegistrationStatusUpdate service operation with a reject indication towards the old AMF. The old AMF continues as if the UE context transfer service operation was never received.

If one or more of the S-NSSAIs used in the old Registration Area cannot be served in the target Registration Area, the new AMF determines which PDU Session cannot be supported in the new Registration Area. The new AMF invokes the Namf_Communication_RegistrationStatusUpdate service operation including the rejected PDU Session ID towards the old AMF. Then the new AMF modifies the PDU Session Status correspondingly. The old AMF informs the corresponding SMF(s) to locally release the UE's SM context by invoking the Nsmf_PDUSession_ReleaseSMContext service operation.

If new AMF received in the UE context transfer in step 2 the information about the AM Policy Association and the UE Policy Association and decides, based on local policies, not to use the PCF(s) identified by the PCF ID(s) for the AM Policy Association and the UE Policy Association, then it will inform the old AMF that the AM Policy Association and the UE Policy Association in the UE context is not used any longer and then the PCF selection is performed in step 15.

If the old AMF used UE related Analytics NWDAF services, it may now unsubscribe the NWDAF services for the UE according to TS 23.288 [50].

11. [Conditional] new AMF to UE: Identity Request/Response (PEI).

If the PEI was not provided by the UE nor retrieved from the old AMF the Identity Request procedure is initiated by AMF sending an Identity Request message to the UE to retrieve the PEI. The PEI shall be transferred encrypted unless the UE performs Emergency Registration and cannot be authenticated.

For an Emergency Registration, the UE may have included the PEI in the Registration Request. If so, the PEI retrieval is skipped.

If the UE supports RACS as indicated in UE MM Core Network Capability, the AMF shall use the PEI of the UE to obtain the IMEI/TAC for the purpose of RACS operation.

12. Optionally the new AMF initiates ME identity check by invoking the N5g-eir_EquipmentIdentityCheck_Get service operation (see clause 5.2.4.2.2).

The PEI check is performed as described in clause 4.7.

For an Emergency Registration, if the PEI is blocked, operator policies determine whether the Emergency Registration procedure continues or is stopped.

13. If step 14 is to be performed, the new AMF, based on the SUPI, selects a UDM, then UDM may select a UDR instance. See TS 23.501 [2], clause 6.3.9.

The AMF selects a UDM as described in TS 23.501 [2], clause 6.3.8.

14a-c. If the AMF has changed since the last Registration procedure, or if the UE provides a SUPI which doesn't refer to a valid context in the AMF, or if the UE registers to the same AMF it has already registered to a non-3GPP access (i.e. the UE is registered over a non-3GPP access and initiates this Registration procedure to add a 3GPP access), the new AMF registers with the UDM using Nudm_UECM_Registration for the access to be registered (and subscribes to be notified when the UDM deregisters this AMF). The AMF includes SUPI-PEI association change indicator in the Nudm_UECM_Registration In this case, if the AMF does not have event exposure subscription information for this UE, the AMF indicates it to UDM. Then, if the UDM has existing applicable event exposure subscriptions for events detected in AMF for this UE or for any of the groups this UE belongs to (possibly retrieved from UDR), UDM invokes the Namf_EventExposure_Subscribe service for recreating the event exposure subscriptions. Upon receiving the SUPI-PEI association change indicator the UDM may provide the subscription information (e.g. CAG information) of the SUPI in Nudm_UECM_Registration response message.

The AMF provides the “Homogenous Support of IMS Voice over PS Sessions” indication (see clause 5.16.3.3 of TS 23.501 [2]) to the UDM. The “Homogenous Support of IMS Voice over PS Sessions” indication shall not be included unless the AMF has completed its evaluation of the support of “IMS Voice over PS Session” as specified in clause 5.16.3.2 of TS 23.501 [2].

During initial Registration, if the AMF and UE supports SRVCC from NG-RAN to UTRAN the AMF provides UDM with the UE SRVCC capability.

If the AMF determines that only the UE SRVCC capability has changed, the AMF sends UE SRVCC capability to the UDM.

NOTE 10: At this step, it is possible that the AMF does not have all the information needed to determine the setting of the IMS Voice over PS Session Supported indication for this UE (see clause 5.16.3.2 of TS 23.501 [2]). Hence the AMF can send the “Homogenous Support of IMS Voice over PS Sessions” later on in this procedure.

If the AMF does not have subscription data for the UE, the AMF retrieves the Access and Mobility Subscription data, SMF Selection Subscription data, UE context in SMF data and LCS mobile origination using Nudm_SDM_Get. If the AMF already has subscription data for the UE but the SoR Update Indicator in the UE context requires the AMF to retrieve SoR information depending on the NAS Registration Type (“Initial Registration” or “Emergency Registration”) (see Annex C of TS 23.122 [22]), the AMF retrieves the Steering of Roaming information using Nudm_SDM_Get. This requires that UDM may retrieve this information from UDR by Nudr_DM_Query. After a successful response is received, the AMF subscribes to be notified using Nudm_SDM_Subscribe when the data requested is modified, UDM may subscribe to UDR by Nudr_DM_Subscribe. The GPSI is provided to the AMF in the Access and Mobility Subscription data from the UDM if the GPSI is available in the UE subscription data. The UDM may provide indication that the subscription data for network slicing is updated for the UE. If the UE is subscribed to MPS in the serving PLMN, “MPS priority” is included in the Access and Mobility Subscription data provided to the AMF. If the UE is subscribed to MCX in the serving PLMN, “MCX priority” is included in the Access and Mobility Subscription data provided to the AMF. The UDM also provides the IAB-Operation allowed indication to AMF as part of the Access and Mobility Subscription data. The AMF shall trigger the setup of the UE context in NG-RAN, or modification of the UE context in NG-RAN if the initial setup is at step 9c, including an indication that the IAB-node is authorized. When the AMF receives the PEI-SUPI association change indicator the AMF may include the PEI-SUPI association change indicator in the Nudm_SDM_Get message and sends it to the UDM. When the UDM receives the PEI-SUPI association change indicator either in Nudm_UECM_Registration message or Nudm_SDM_GET message then the UDM includes UE subscription information (e.g. CAG information) the AMF.

The new AMF provides the Access Type it serves for the UE to the UDM and the Access Type is set to “3GPP access”. The UDM stores the associated Access Type together with the serving AMF and does not remove the AMF identity associated to the other Access Type if any. The UDM may store in UDR information provided at the AMF registration by Nudr_DM_Update.

If the UE was registered in the old AMF for an access, and the old and the new AMFs are in the same PLMN, the new AMF sends a separate/independent Nudm_UECM_Registration to update UDM with Access Type set to access used in the old AMF, after the old AMF relocation is successfully completed.

The new AMF creates an UE context for the UE after getting the Access and Mobility Subscription data from the UDM. The Access and Mobility Subscription data includes whether the UE is allowed to include NSSAI in the 3GPP access RRC Connection Establishment in clear text. The Access and Mobility Subscription data may include Enhanced Coverage Restricted information. If received from the UDM and the UE included support for restriction of use of Enhanced Coverage in step 1, the AMF determines whether Enhanced Coverage is restricted or not for the UE as specified in TS 23.501 [2] clause 5.31.12 and stores the updated Enhanced Coverage Restricted information in the UE context.

The Access and Mobility Subscription data may include the NB-IOT UE Priority.

The subscription data may contain Service Gap Time parameter. If received from the UDM, the AMF stores this Service Gap Time in the UE Context in AMF for the UE.

For an Emergency Registration in which the UE was not successfully authenticated, the AMF shall not register with the UDM.

The AMF enforces the Mobility Restrictions as specified in TS 23.501 [2] clause 5.3.4.1.1. For an Emergency Registration, the AMF shall not check for Mobility Restrictions, access restrictions, regional restrictions or subscription restrictions. For an Emergency Registration, the AMF shall ignore any unsuccessful registration response from UDM and continue with the Registration procedure.

NOTE 11: The AMF can, instead of the Nudm_SDM_Get service operation, use the Nudm_SDM_Subscribe service operation with an Immediate Report Indication that triggers the UDM to immediately return the subscribed data if the corresponding feature is supported by both the AMF and the UDM.

14d. When the UDM stores the associated Access Type (e.g. 3GPP) together with the serving AMF as indicated in step 14a, it will cause the UDM to initiate a Nudm_UECM_DeregistrationNotification (see clause 5.2.3.2.2) to the old AMF corresponding to the same (e.g. 3GPP) access, if one exists. If the timer started in step 5 is not running, the old AMF may remove the UE context for the same Access Type. Otherwise, the AMF may remove UE context for the same Access Type when the timer expires. If the serving NF removal reason indicated by the UDM is Initial Registration, then, as described in clause 4.2.2.3.2, the old AMF invokes the Nsmf_PDUSession_ReleaseSMContext (SM Context ID) service operation towards all the associated SMF(s) of the UE to notify that the UE is deregistered from old AMF for the same Access Type. The SMF(s) shall release the PDU Session on getting this notification.

If the old AMF has established an AM Policy Association and a UE Policy Association with the PCF(s), and the old AMF did not transfer the PCF ID(s) to the new AMF (e.g. new AMF is in different PLMN), the old AMF performs an AMF-initiated Policy Association Termination procedure, as defined in clause 4.16.3.2, and performs an AMF-initiated UE Policy Association Termination procedure, as defined in clause 4.16.13.1. In addition, if the old AMF transferred the PCF ID(s) in the UE context but the new AMF informed in step 10 that the AM Policy Association information and UE Policy Association information in the UE context will not be used then the old AMF performs an AMF-initiated Policy Association Termination procedure, as defined in clause 4.16.3.2, and performs an AMF-initiated UE Policy Association Termination procedure, as defined in clause 4.16.13.1.

If the old AMF has an N2 connection for that UE (e.g. because the UE was in RRC Inactive state but has now moved to E-UTRAN or moved to an area not served by the old AMF), the old AMF shall perform AN Release (see clause 4.2.6) with a cause value that indicates that the UE has already locally released the NG-RAN's RRC Connection.

At the end of registration procedure, the AMF may initiate synchronization of event exposure subscriptions with the UDM if the AMF does not indicate unavailability of event exposure subscription in step 14a.

NOTE 12: The AMF can initiate synchronization with UDM even if events are available in the UE context (e.g. as received from old AMF) at any given time and based on local policy. This can be done during subscription change related event.

14e. [Conditional] If old AMF does not have UE context for another access type (i.e. non-3GPP access), the Old AMF unsubscribes with the UDM for subscription data using Nudm_SDM_unsubscribe.

15. If the AMF decides to initiate PCF communication, the AMF acts as follows.

If the new AMF decides to use the (V-)PCF identified by the (V-)PCF ID included in UE context from the old AMF in step 5, the AMF contacts the (V-)PCF identified by the (V-)PCF ID to obtain policy. If the AMF decides to perform PCF discovery and selection and the AMF selects a (V)-PCF and may select an H-PCF (for roaming scenario) as described in TS 23.501 [2], clause 6.3.7.1 and according to the V-NRF to H-NRF interaction described in clause 4.3.2.2.3.3.

16. [Optional] new AMF performs an AM Policy Association Establishment/Modification. For an Emergency Registration, this step is skipped.

If the new AMF selects a new (V-)PCF in step 15, the new AMF performs AM Policy Association Establishment with the selected (V-)PCF as defined in clause 4.16.1.2.

If the (V-)PCF identified by the (V-)PCF ID included in UE context from the old AMF is used, the new AMF performs AM Policy Association Modification with the (V-)PCF as defined in clause 4.16.2.1.2.

If the AMF notifies the Mobility Restrictions (e.g. UE location) to the PCF for adjustment, or if the PCF updates the Mobility Restrictions itself due to some conditions (e.g. application in use, time and date), the PCF shall provide the updated Mobility Restrictions to the AMF. If the subscription information includes Tracing Requirements, the AMF provides the PCF with Tracing Requirements.

If the AMF supports DNN replacement, the AMF provides the PCF with the Allowed NSSAI and, if available, the Mapping Of Allowed NSSAI.

If the PCF supports DNN replacement, the PCF provides the AMF with triggers for DNN replacement.

17. [Conditional] AMF to SMF: Nsmf_PDUSession_UpdateSMContext ( ).

For an Emergency Registered UE (see TS 23.501 [2]), this step is applied when the Registration Type is Mobility Registration Update.

The AMF invokes the Nsmf_PDUSession_UpdateSMContext (see clause 5.2.8.2.6) in the following scenario(s):
If the List Of PDU Sessions To Be Activated is included in the Registration Request in step 1, the AMF sends Nsmf_PDUSession_UpdateSMContext Request to SMF(s) associated with the PDU Session(s) in order to activate User Plane connections of these PDU Session(s). Steps from step 5 onwards described in clause 4.2.3.2 are executed to complete the User Plane connection activation without sending the RRC Inactive Assistance Information and without sending MM NAS Service Accept from the AMF to (R)AN described in step 12 of clause 4.2.3.2. When a User Plane connection for a PDU Session is activated, the AS layer in the UE indicates it to the NAS layer.
If the AMF has determined in step 3 that the UE is performing Inter-RAT mobility to or from NB-IOT, the AMF sends Nsmf_PDUSession_UpdateSMContext Request to SMF(s) associated with the UEs PDU Session(s), so the SMF(s) can update them according to the “PDU Session continuity at inter RAT mobility” subscription data. Steps from step 5 onwards described in clause 4.2.3.2 are executed without sending MM NAS Service Accept from the AMF to (R)AN described in step 12 of clause 4.2.3.2.

When the serving AMF has changed, the new serving AMF notifies the SMF for each PDU Session that it has taken over the responsibility of the signalling path towards the UE: the new serving AMF invokes the Nsmf_PDUSession_UpdateSMContext service operation using SMF information received from the old AMF at step 5. It also indicates whether the PDU Session is to be re-activated.

NOTE 13: If the UE moves into a different PLMN, the AMF in the serving PLMN can insert or change the V-SMF(s) in the serving PLMN for Home Routed PDU session(s). In this case, the same procedures described in clause 4.23.3 are applied for the V-SMF change as for the I-SMF change (i.e. by replacing the I-SMF with V-SMF). During inter-PLMN change, if the same SMF is used, session continuity can be supported depending on operator policies.

Steps from step 5 onwards described in clause 4.2.3.2 are executed. In the case that the intermediate UPF insertion, removal, or change is performed for the PDU Session(s) not included in “PDU Session(s) to be re-activated”, the procedure is performed without N11 and N2 interactions to update the N3 user plane between (R)AN and 5GC.

The AMF invokes the Nsmf_PDUSession_ReleaseSMContext service operation towards the SMF in the following scenario:
If any PDU Session status indicates that it is released at the UE, the AMF invokes the Nsmf_PDUSession_ReleaseSMContext service operation towards the SMF in order to release any network resources related to the PDU Session.

If the serving AMF is changed, the new AMF shall wait until step 18 is finished with all the SMFs associated with the UE. Otherwise, steps 19 to 22 can continue in parallel to this step.

18. [Conditional] If the new AMF and the old AMF are in the same PLMN, the new AMF sends a UE Context Modification Request to N3IWF/TNGF/W-AGF as specified in TS 29.413 [64].

If the AMF has changed and the old AMF has indicated that the UE is in CM-CONNECTED state via N3IWF, W-AGF or TNGF and if the new AMF and the old AMF are in the same PLMN, the new AMF creates an NGAP UE association towards the N3IWF/TNGF/W-AGF to which the UE is connected. This automatically releases the existing NGAP UE association between the old AMF and the N3IWF/TNGF/W-AGF.

19. N3IWF/TNGF/W-AGF sends a UE Context Modification Response to the new AMF.

19a. [Conditional] After the new AMF receives the response message from the N3IWF, W-AGF or TNGF in step 19, the new AMF registers with the UDM using Nudm_UECM_Registration as step 14a, but with the Access Type set to “non-3GPP access”. The UDM stores the associated Access Type together with the serving AMF and does not remove the AMF identity associated to the other Access Type if any. The UDM may store in UDR information provided at the AMF registration by Nudr_DM_Update.

19b. [Conditional] When the UDM stores the associated Access Type (i.e. non-3GPP) together with the serving AMF as indicated in step 19a, it will cause the UDM to initiate a Nudm_UECM_DeregistrationNotification (see clause 5.2.3.2.2) to the old AMF corresponding to the same (i.e. non-3GPP) access. The old AMF removes the UE context for non-3GPP access. 19c. The Old AMF unsubscribes with the UDM for subscription data using Nudm_SDM_unsubscribe.

20a. Void.

21. New AMF to UE: Registration Accept (5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [Truncated 5G-S-TMSI Configuration]).

If the Requested NSSAI does not include S-NSSAIs which map to S-NSSAIs of the HPLMN subject to Network Slice-Specific Authentication and Authorization and the AMF determines that no S-NSSAI can be provided in the Allowed NSSAI for the UE in the current UE's Tracking Area and if no default S-NSSAI(s) not yet involved in the current UE Registration procedure could be further considered, the AMF shall reject the UE Registration and shall include in the rejection message the list of Rejected S-NSSAIs, each of them with the appropriate rejection cause value.

The Allowed NSSAI for the Access Type for the UE is included in the N2 message carrying the Registration Accept message. The Allowed NSSAI contains only S-NSSAIs that do not require, based on subscription information, Network Slice-Specific Authentication and Authorization and, based on the UE Context in the AMF, those S-NSSAIs for which Network Slice-Specific Authentication and Authorization previously succeeded, regardless of the Access Type. The Mapping Of Pending NSSAI is the mapping of each S-NSSAI of the Pending NSSAI for the Serving PLMN to the HPLMN S-NSSAIS.

If the UE has indicated its support for Network Slice-Specific Authentication and Authorization procedure in the UE MM Core Network Capability in the Registration Request, AMF includes in the Pending NSSAI the S-NSSAIs that map to an S-NSSAI of the HPLMN which in the subscription information has indication that it is subject to Network Slice-Specific Authentication and Authorization, as described in clause 4.6.2.4 of TS 24.501 [25]. In such case, the AMF then shall trigger at step 25 the Network Slice-Specific Authentication and Authorization procedure, specified in clause 4.2.9.2, except, based on Network policies, for those S-NSSAIs for which Network Slice-Specific Authentication and Authorization have already been initiated on another Access Type for the same S-NSSAI(s). The UE shall not attempt re-registration with the S-NSSAIs included in the list of Pending NSSAIs until the Network Slice-Specific Authentication and Authorization procedure has been completed, regardless of the Access Type.

If the UE has not indicated its support for Network Slice-Specific Authentication and Authorization procedure in the UE 5GMM Core Network Capability in the Registration Request, and the Requested NSSAI includes S-NSSAIs which map to HPLMN S-NSSAIs subject to Network Slice-Specific Authentication and Authorization, the AMF includes those S-NSSAIs in the Requested NSSAI in the Rejected S-NSSAIs.

If no S-NSSAI can be provided in the Allowed NSSAI because:
all the S-NSSAI(s) in the Requested NSSAI are to be subject to Network Slice-Specific Authentication and Authorization; or
no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to Network Slice-Specific Authentication and Authorization.

The AMF shall provide an empty Allowed NSSAI. Upon receiving an empty Allowed NSSAI and a Pending NSSAI, the UE is registered in the PLMN but shall wait for the completion of the Network Slice-Specific Authentication and Authorization procedure without attempting to use any service provided by the PLMN on any access, except e.g. emergency services (see TS 24.501 [25]), until the UE receives an Allowed NSSAI.

The AMF stores the NB-IOT Priority retrieved in Step 14 and associates it to the 5G-S-TMSI allocated to the UE.

The AMF sends a Registration Accept message to the UE indicating that the Registration Request has been accepted. 5G-GUTI is included if the AMF allocates a new 5G-GUTI. Upon receiving a Registration Request message of type “Initial Registration” or “mobility registration update” from the UE, the AMF shall include a new 5G-GUTI in the Registration Accept message. Upon receiving a Registration Request message of type “periodic registration update” from the UE, the AMF should include a new 5G-GUTI in the Registration Accept message. If the UE is already in RM-REGISTERED state via another access in the same PLMN, the UE shall use the 5G-GUTI received in the Registration Accept for both registrations. If no 5G-GUTI is included in the Registration Accept, then the UE uses the 5G-GUTI assigned for the existing registration also for the new registration. If the AMF allocates a new Registration area, it shall send the Registration area to the UE via Registration Accept message. If there is no Registration area included in the Registration Accept message, the UE shall consider the old Registration Area as valid. Mobility Restrictions is included if mobility restrictions applies for the UE and Registration Type is not Emergency Registration. The AMF indicates the established PDU Sessions to the UE in the PDU Session status. The UE removes locally any internal resources related to PDU Sessions that are not marked as established in the received PDU Session status. If the AMF invokes the Nsmf_PDUSession_UpdateSMContext procedure for UP activation of PDU Session(s) in step 18 and receives rejection from the SMF, then the AMF indicates to the UE the PDU Session ID and the cause why the User Plane resources were not activated. When the UE is connected to the two AMFs belonging to different PLMN via 3GPP access and non-3GPP access then the UE removes locally any internal resources related to the PDU Session of the current PLMN that are not marked as established in received PDU Session status. If the PDU Session status information was in the Registration Request, the AMF shall indicate the PDU Session status to the UE.

If the RAT Type is NB-IOT and the network is configured to use the Control Plane Relocation Indication procedure then the AMF shall include in the Registration Accept message the Truncated 5G-S-TMSI Configuration that the UE using Control Plane CIOT 5GS Optimisation uses to create the Truncated 5G-S-TMSI, see TS 23.501 [2] clause 5.31.4.3.

The Allowed NSSAI provided in the Registration Accept is valid in the Registration Area and it applies for all the PLMNs which have their Tracking Areas included in the Registration Area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the Serving PLMN to the HPLMN S-NSSAIS.

The AMF shall include in the Registration Accept message the LADN Information for the list of LADNs, described in TS 23.501 [2] clause 5.6.5, that are available within the Registration area determined by the AMF for the UE. The AMF may include Operator-defined access category definitions to let the UE determine the applicable Operator-specific access category definitions as described in TS 24.501 [25].

If the UE included MICO mode in the Registration Request, then AMF responds in the Registration Accept message whether MICO mode should be used. When MICO mode is allowed for the UE, the AMF may include an Active Time value and/or Strictly Periodic Registration Timer Indication in the Registration Accept message. The AMF determines the Periodic Registration Update timer value, Active Time value and the Strictly Periodic Registration Timer Indication based on local configuration, Expected UE Behaviour if available, UE indicated preferences, UE capability, UE subscription information and network policies, or any combination of them so as to enable UE power saving, as described in TS 23.501 [2], clause 5.31.7. The AMF determines to apply the Strictly Periodic Registration Timer Indication to the UE if the UE indicates its capability of the Strictly Periodic Registration Timer Indication in the registration request message, as described in step 1. If the AMF provides the Periodic Registration Update timer value with the Strictly Periodic Registration Timer Indication to the UE, the UE and the AMF start the Periodic Registration Update timer after this step, as described in TS 23.501 [2], clause 5.31.7.5.

In the case of registration over 3GPP access, the AMF Sets the IMS Voice over PS session supported Indication as described in clause 5.16.3.2 of TS 23.501 [2]. In order to set the IMS Voice over PS session supported Indication the AMF may need to perform the UE Capability Match Request procedure in clause 4.2.8a to check the compatibility of the UE and NG-RAN radio capabilities related to IMS Voice over PS. If the AMF hasn't received Voice Support Match Indicator from the NG-RAN on time then, based on implementation, AMF may set IMS Voice over PS session supported Indication and update it at a later stage.

In the case of registration over non-3GPP access, the AMF Sets the IMS Voice over PS session supported Indication as described in clause 5.16.3.2a of TS 23.501 [2].

The Emergency Service Support indicator informs the UE that emergency services are supported, i.e. the UE is allowed to request PDU Session for emergency services. If the AMF received “MPS priority” from the UDM as part of Access and Mobility Subscription data, based on operator policy, “MPS priority” is included in the Registration Accept message to the UE to inform the UE whether configuration of Access Identity 1 is valid within the selected PLMN, as specified in TS 24.501 [25]. If the AMF received “MCX priority” from the UDM as part of Access and Mobility Subscription data, based on operator policy and UE subscription to MCX Services, “MCX priority” is included in the Registration Accept message to the UE to inform the UE whether configuration of Access Identity 2 is valid within the selected PLMN, as specified in TS 24.501 [25]. The Accepted DRX parameters are defined in clause 5.4.5 of TS 23.501 [2]. The AMF includes Accepted DRX parameters for NB-IOT, if the UE included Requested DRX parameters for NB-IOT in the Registration Request message. The AMF Sets the Network support of Interworking without N26 parameter as described in clause 5.17.2.3.1 of TS 23.501 [2]. If the AMF accepts the use of extended idle mode DRX, the AMF includes the extended idle mode DRX parameters and Paging Time Window as described in 5.31.7.2 of TS 23.501 [2].

If the UDM intends to indicate the UE that subscription has changed, the Network Slicing Subscription Change Indication is included. If the AMF includes Network Slicing Subscription Change Indication, then the UE shall locally erase all the network slicing configuration for all PLMNs and, if applicable, update the configuration for the current PLMN based on any received information.

The Access Stratum Connection Establishment NSSAI Inclusion Mode, as specified in TS 23.501 [2] clause 5.15.9, is included to instruct the UE on what NSSAI, if any, to include in the Access Stratum connection establishment. The AMF can set the value to modes of operation a, b, c defined in TS 23.501 [2] clause 5.15.9 in the 3GPP Access only if the Inclusion of NSSAI in RRC Connection Establishment Allowed indicates that it is allowed to do so.

For a UE registered in a PLMN, the AMF may provide a List of equivalent PLMNs which is handled as specified in TS 24.501 [25]. For a UE registered in an SNPN, the AMF shall not provide a list of equivalent PLMNs to the UE.

If the UE included support for restriction of use of Enhanced Coverage in step 1, the AMF sends the Enhanced Coverage Restricted information to the NG-RAN in N2 message. The AMF also sends Enhanced Coverage Restricted information to the UE in the Registration Accept message.

If the UE receives Enhanced Coverage Restricted information in the Registration Accept message, the UE shall store this information and shall use the value of Enhanced Coverage Restricted information to determine if Enhanced Coverage feature should be used or not.

If the UE and the AMF have negotiated to enable MICO mode and the AMF uses the Extended connected timer, then the AMF provides the Extended Connected time value to NG-RAN (see clause 5.31.7.3 of TS 23.501 [2]) in this step. The Extended Connected Time value indicates the minimum time the RAN should keep the UE in RRC-CONNECTED state regardless of inactivity.

The AMF indicates the CIOT 5GS Optimisations it supports and accepts in the Supported Network Behaviour information (see TS 23.501 [2], clause 5.31.2) if the UE included Preferred Network Behaviour in its Registration Request.

The AMF may steer the UE from 5GC by rejecting the Registration Request. The AMF should take into account the Preferred and Supported Network Behaviour (see TS 23.501 [2], clause 5.31.2) and availability of EPC to the UE before steering the UE from 5GC.

If the AMF accepts MICO mode and knows there may be mobile terminated data or signalling pending, the AMF maintains the N2 connection for at least the Extended Connected Time as described in clause 5.31.7.3 of TS 23.501 [2], and provides the Extended Connected Time value to the RAN.

The AMF includes Service Gap Time if Service Gap Time is present in the subscription information (steps 14a-c) or the Service Gap Time has been updated by the Subscriber Data Update Notification to AMF procedure (see clause 4.5.1) and the UE has indicated UE Service Gap Control Capability.

If the UE receives a Service Gap Time in the Registration Accept message, the UE shall store this parameter and apply Service Gap Control (see TS 23.501 [2] clause 5.31.16).

If the network supports WUS grouping (see TS 23.501 [2]), the AMF shall send the WUS Assistance Information to the UE. If the UE provided the UE paging probability information in Step 1, the AMF takes it into account to determine the WUS Assistance Information.

When the UE and the AMF supports RACS as defined in TS 23.501 [2] clause 5.4.4.1a, and the AMF needs to configure the UE with a UE Radio Capability ID, and the AMF already has the UE radio capabilities other than NB-IOT radio capabilities for the UE, the AMF may provide the UE with the UE Radio Capability ID for the UE radio capabilities the UCMF returns to the AMF in a Nucmf_assign service operation for this UE. Alternatively, when the UE and the AMF support RACS, the AMF may provide the UE with an indication to delete any PLMN-assigned UE Radio Capability ID in this PLMN (see TS 23.501 [2] clause 5.4.4.1a).

If the UE is “CAG supported”, and the AMF needs to update the CAG information of the UE, the AMF may include the CAG information as part of the Mobility Restrictions in the Registration Accept message.

21b. [Optional] The new AMF performs a UE Policy Association Establishment as defined in clause 4.16.11. For an Emergency Registration, this step is skipped.

The new AMF sends a Npcf_UEPolicyControl Create Request to PCF. PCF sends a Npcf_UEPolicyControl Create Response to the new AMF.

PCF triggers UE Configuration Update Procedure as defined in clause 4.2.4.3.

22. [Conditional] UE to new AMF: Registration Complete ( ).

The UE sends a Registration Complete message to the AMF when it has successfully updated itself after receiving any of the [Configured NSSAI for the Serving PLMN], [Mapping Of Configured NSSAI] and a Network Slicing Subscription Change Indication, or CAG information in step 21.

The UE sends a Registration Complete message to the AMF to acknowledge if a new 5G-GUTI was assigned.

If new 5G-GUTI was assigned, then the UE passes the new 5G-GUTI to its 3GPP access' lower layer when a lower layer (either 3GPP access or non-3GPP access) indicates to the UE's RM layer that the Registration Complete message has been successfully transferred across the radio interface.

NOTE 14: The above is needed because the NG-RAN may use the RRC Inactive state and a part of the 5G-GUTI is used to calculate the Paging Frame (see TS 38.304 and TS 36.304 [43]). It is assumed that the Registration Complete is reliably delivered to the AMF after the 5G-AN has acknowledged its receipt to the UE.

When the List Of PDU Sessions To Be Activated is not included in the Registration Request and the Registration procedure was not initiated in CM-CONNECTED state, the AMF releases the signalling connection with UE, according to clause 4.2.6.

When the Follow-on request is included in the Registration Request, the AMF should not release the signalling connection after the completion of the Registration procedure.

If the AMF is aware that some signalling is pending in the AMF or between the UE and the 5GC, the AMF should not release the signalling connection immediately after the completion of the Registration procedure.

If PLMN-assigned UE Radio Capability ID is included in step 21, the AMF stores the PLMN-assigned UE Radio Capability ID in UE context if receiving Registration Complete message.

If the UE receives PLMN-assigned UE Radio Capability ID deletion indication in step 21, the UE shall delete the PLMN-assigned UE Radio Capability ID(s) for this PLMN.

23. [Conditional] AMF to UDM: If the Access and Mobility Subscription data provided by UDM to AMF in 14b includes Steering of Roaming information with an indication that the UDM requests an acknowledgement of the reception of this information from the UE, the AMF provides the UE acknowledgement to UDM using Nudm_SDM_Info. For more details regarding the handling of Steering of Roaming information refer to TS 23.122 [22].

23a. For Registration over 3GPP Access, if the AMF does not release the signalling connection, the AMF sends the RRC Inactive Assistance Information to the NG-RAN.

For Registration over non-3GPP Access, if the UE is also in CM-CONNECTED state on 3GPP access, the AMF sends the RRC Inactive Assistance Information to the NG-RAN.

The AMF also uses the Nudm_SDM_Info service operation to provide an acknowledgment to UDM that the UE received CAG information, or the Network Slicing Subscription Change Indication (see step 21 and step 22) and acted upon it.

24. [Conditional] AMF to UDM: After step 14a, and in parallel to any of the preceding steps, the AMF shall send a “Homogeneous Support of IMS Voice over PS Sessions” indication to the UDM using Nudm_UECM_Update:
If the AMF has evaluated the support of IMS Voice over PS Sessions, see clause 5.16.3.2 of TS 23.501 [2], and
If the AMF determines that it needs to update the Homogeneous Support of IMS Voice over PS Sessions, see clause 5.16.3.3 of TS 23.501 [2].

25. [Conditional] If the UE indicates its support for Network Slice-Specific Authentication and Authorization procedure in the UE MM Core Network Capability in Registration Request, and any S-NSSAI of the HPLMN is subject to Network Slice-Specific Authentication and Authorization, the related procedure is executed at this step (see clause 4.2.9.1). Once the Network Slice-Specific Authentication and Authorization procedure is completed for all S-NSSAIs, the AMF shall trigger a UE Configuration Update procedure to deliver an Allowed NSSAI containing also the S-NSSAIs for which the Network Slice-Specific Authentication and Authorization was successful, and include any rejected NSSAIs with an appropriate rejection cause value.

The AMF shall remove the mobility restriction if the Tracking Areas of the Registration Area were previously assigned as a Non-Allowed Area due to pending Network Slice-Specific Authentication and Authorization.

The AMF stores an indication in the UE context for any S-NSSAI of the HPLMN subject to Network Slice-Specific Authentication and Authorization for which the Network Slice-Specific Authentication and Authorization succeeds.

Once completed the Network Slice-Specific Authentication and Authorization procedure, if the AMF determines that no S-NSSAI can be provided in the Allowed NSSAI for the UE, which is already authenticated and authorized successfully by a PLMN, and if no default S-NSSAI(s) could be further considered, the AMF shall execute the Network-initiated Deregistration procedure described in clause 4.2.2.3.3, and shall include in the explicit De-Registration Request message the list of Rejected S-NSSAIs, each of them with the appropriate rejection cause value.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111016593, filed on Apr. 8, 2021, the disclosure of which is incorporated herein in its entirety by reference.

### REFERENCE SIGNS LIST

1 USIM
2 ME
3 UE
5 (R)AN node
10 AMF
11 AUSF
15 UDM
16 EIR
31 transceiver circuit
32 antenna
33 controller
34 user interface
35 USIM
36 memory
51 transceiver circuit
52 antenna
53 network interface
54 controller
55 memory
101 transceiver circuit
102 network interface
103 controller
104 memory
151 transceiver circuit
152 network interface
153 controller
154 memory
161 transceiver circuit
162 network interface
163 controller
164 memory
361 operating system
362 communications control module
551 operating system
552 communications control module
1041 operating system
1042 communications control module
1541 operating system
1542 communications control module
1641 operating system
1642 communications control module
3621 transceiver control module
5521 transceiver control module
10421 transceiver control module
15421 transceiver control module
16421 transceiver control module

What is claimed is:

1.-50. (canceled)

51. A method for a Unified Data Management Function (UDM) comprising:
keeping information for a Permanent Equipment Identifier (PEI) regarding a User Equipment (UE); and
sending, to an Access Management Function (AMF), first information regarding the UE based on the information for the PEI.

52. The method according to claim 51 comprising:
sending an instruction to the AMF to send, to the UE, second information.

53. A method for an Access Management Function (AMF) comprising:
receiving, from a Unified Data Management Function (UDM), first information regarding a User Equipment (UE) based on information for a Permanent Equipment Identifier (PEI).

54. The method according to claim 53 comprising:
receiving an instruction, from the UDM, to send to the UE, second information.

55. A Unified Data Management Function (UDM) comprising:
at least one memory; and
at least one processor configured to access the memory and configured to:
keep information for a Permanent Equipment Identifier (PEI) regarding a User Equipment (UE); and
send, to an Access Management Function (AMF), first information regarding the UE based on the information for the PEI.

56. The UDM according to claim 55, wherein the at least one processor is configured to send an instruction to the AMF to send, to the UE, second information.

57. An Access Management Function (AMF) comprising:
at least one memory; and
at least one processor configured to access the memory and configured to:
receive, from a Unified Data Management Function (UDM), first information regarding a UE based on information for a Permanent Equipment Identifier (PEI).

58. The AMF according to claim 57, wherein the at least one processor is configured to receive an instruction, from the UDM, to send to the UE, second information.
